(19) United States
(12) Patent Application Publication
(10) Pub. No.: US 2025/0218756 A1
(43) Pub. Date: Jul. 3, 2025

(54) TRAPPED ION MOBILITY SEPARATOR WITH A MOVING ELECTRIC FIELD BARRIER

(71) Applicant: Bruker Daltonics GmbH & Co. KG, Bremen (DE)

(72) Inventor: Karsten MICHELMANN, Bremen (DE)

(21) Appl. No.: 18/999,008

(22) Filed: Dec. 23, 2024

Related U.S. Application Data
(60) Provisional application No. 63/616,147, filed on Dec. 29, 2023.

(51) Int. Cl. H01J 49/06; G01N 27/623; H01J 49/00; H01J 49/24

(52) U.S. Cl. CPC H01J 49/062; G01N 27/623; H01J 49/0031; H01J 49/24

(57) ABSTRACT

The invention relates to a method for separating ions and a trapped ion mobility separator. The trapped ion mobility separator comprises an ion guide extending in a closed loop which contains a gas substantially at rest through which ions pass. An axial force acting on the ions is provided, being caused by an electric field barrier providing an electric field gradient that moves around the ion guide, and having an effect on the movement of the ions that is dependent on ion mobility. At least one operating parameter of the trapped ion mobility separator, which has an impact on the mobility separation, is varied as a function of time, so that the ions are pushed controlled along the moving electric field barrier towards a high potential end of the electric field barrier, wherein the ions are ejected laterally from the ion guide before slipping over said electric field barrier.

### BACKGROUND OF THE INVENTION

### Field of the Invention

The disclosure relates to an apparatus and method for separating ions according to a principle of ion mobility spectrometry (IMS). In particular, the invention relates to a trapped ion mobility separator and a method for analyzing ions according to their ion mobility. The apparatus and method are suitable for use in combination with mass spectrometry (MS), e.g. in hybrid IMS/MS instruments.

### Description of the Related Art

Ion mobility spectrometry (IMS) is an analytical technique that is used to investigate the mobility of ions in a gas and to separate them according to their mobility.

An inherent feature of ion mobility spectrometry is that the mobility of ions in a gas depends on molecular geometries of the ions such that it is often possible to resolve and thus separate isomers or conformers that cannot be resolved by mass spectrometry. Many applications also take advantage of the ability to determine the cross section of an analyte ion from its measured mobility. Knowledge of mobilities or cross sections has proven to be significant in many areas including identifying analytes (e.g., in proteomics and metabolomics), separating compound classes and determining molecular structures (e.g., in structural biology).

In trapped ion mobility spectrometry, ions are typically trapped by a spatially non-uniform DC electric field and a counteracting gas flow, or by a spatially uniform electric DC field and a counteracting gas flow which has a spatially non-uniform axial velocity profile along the axis. The trapped ions are separated in space according to ion mobility and are subsequently eluted over time according to their mobility by adjusting either the gas velocity or the strength of the axial electric DC field (see, e.g., U.S. Pat. No. 6,630,662 B1 by Loboda and U.S. Pat. No. 7,838,826 B1 by Park). The theoretical basis of trapped ion mobility spectrometry is also described, for example, in the article “Fundamentals of Trapped Ion Mobility Spectrometry” by Michelmann et al. (J. Am. Soc. Mass Spectrom., 2015, 26, 14-24).

It is of general interest to continuously improve the performance of trapped ion mobility separators, e.g. resolution and charge capacity. In the context of the disclosure, a trapped ion mobility separator is hereinafter referred to as a “TIMS”.

The patent U.S. Pat. No. 9,429,543 B2 discloses an ion mobility analyzer that comprises an electrode system that surrounds the analytical space and a power device that attaches to the electrode system an ion mobility electric potential field that moves along one space axis. During the process of analyzing mobility of ions to be measured, by always placing the ions to be measured in the moving ion mobility electric potential field, and keeping the movement direction of the ion mobility electric potential field consistent with the direction of the electric field on the ions to be measured within the ion mobility electric potential field, theoretically a mobility path of an infinite length can be formed so as to distinguish ions having mobility or ion cross sections that have very small differences.

The following publications provide additional insight into the technical background of the present disclosure, without claiming completeness:

The patent application publications WO 2013093513 A1 and WO 2013093515 A1 each relate to an ion mobility separator comprising an RF ion guide having a plurality of electrodes that are arranged to form an ion guiding path that extends in a closed loop. A DC voltage gradient is maintained along at least a portion of a longitudinal axis of the ion guide, wherein the voltage gradient urges ions to undergo one or more cycles around the ion guide and thus causes the ions to separate according to their ion mobility as they pass along the ion guide. The ion guide described in WO 2013093513 A1 provides an ion exit region at a fixed location on the ion guide, whereas the ion guide described in WO 2013093515 A1 provides an ion exit region which moves around said ion guide such that ions exit said ion guide at different locations at different times.

Further devices for separating ions according to their ion mobility providing a closed loop ion guiding path are disclosed, for example, in the patent application publications WO 2007066114 A2, WO 2013124207 A1 and WO 2015136266 A1.

In view of the foregoing, the present invention is based on the task of advancing and enriching the state of the art. In particular, the invention aims at providing a trapped ion mobility separator with an increased mobility resolution. Further objectives to be achieved may readily be recognized by the person having ordinary skill in the art upon reading the following disclosure. Finally, there is still a need to expand and improve the analysis capabilities of hybrid mass spectrometric systems.

### SUMMARY OF THE INVENTION

The invention solves the task on which it is based with a method of separating ions according to their ion mobility according to claim 1, a trapped ion mobility separator according to claim 19, and a mass spectrometric system according to claim 32, Advantageous embodiments of the invention are subject of the dependent claims and are explained in more detail in the following description.

In a first aspect the invention provides a method of separating ions according to their ion mobility comprising the steps of:
providing an ion guide extending in a closed loop, with at least one ion entrance region at which ions are injected into said ion guide, said ion guide containing a gas which is substantially at rest and through which the ions pass along a drift length of said ion guide, and said ion guide comprising a plurality of electrodes shaped and arranged to guide the ions along said drift length of said ion guide, wherein at least some of the electrodes are supplied at least temporally with confining potentials for preventing the ions from escaping said ion guide laterally,
generating an axial force that is imparted to the ions along said drift length of said ion guide by applying potentials to the electrodes for forming at least one electric field barrier within said ion guide that has a low electric field end and a high electric field end and that moves, for example repeatedly, cyclically or periodically, around said closed loop ion guide, wherein the moving electric field barrier comprises at least a first section represented by an electric field gradient, and wherein the moving electric field barrier urges the ions to move along said drift length of said ion guide whereby the ions are separated according to their ion mobility along said electric field barrier,
varying at least one operating parameter, which has an impact on the mobility separation, as a function of time while moving said electric field barrier around said closed loop ion guide, for pushing at least one ion species controlled along said first section of the moving electric field barrier towards said high electric field end of said electric field barrier; and
providing at least one ion exit region in said ion guide and ejecting the at least one ion species laterally from said ion guide in said at least one ion exit region before slipping over said moving electric field barrier.

Thus, a trapped ion mobility separator according to the invention is named as moving barrier trapped ion mobility separator (mbTIMS).

The invention is based on the realization that the resolution of a trapped ion mobility separator can be increased by providing an electric field barrier that moves, for example repeatedly cyclically or periodically, around a closed loop ion guide and varying at least one operating parameter as a function of time while moving said electric field barrier around said closed loop ion guide, for pushing at least one ion species controlled along said first section of the moving electric field barrier towards said high electric field end of said electric field barrier. In the context of the present disclosure the wording moving cyclically or periodically around the closed loop ion guide can mean both, a single and a multiple circulation, whereby a period duration can differ for individual circulations in the case of multiple circulations. In the context of the present disclosure an operating parameter is to be understood as a variable physical quantity which can be modified during the operation of a device, in this case a device for separating ions, in particular a trapped ion mobility separator. In particular, the operating parameter can control a movement speed or the electric field strength of the moving electric field barrier, or a pressure or a temperature of the gas through which the ions pass within the ion guide. Thus, varying at least one operating parameter as a function of time while moving said electric field barrier around said closed loop ion guide can comprise varying a movement speed and/or the electric field strength of the moving electric field barrier, and/or varying a pressure and/or a temperature of the gas through which the ions pass within the ion guide as a function of time while moving said electric field barrier around said closed loop ion guide.

In a preferred embodiment, the step of varying at least one operating parameter, which has an impact on the mobility separation, can comprise varying at least one of the characteristics of (i) increasing a movement speed of said electric field barrier, (ii) decreasing the electric field strength of said moving electric field barrier, (iii) increasing a pressure of said gas through which the ions pass, and (iv) decreasing a temperature of said gas through which the ions pass. Preferably, the step of varying at least one operating parameter comprises varying exclusively one of the aforementioned characteristics in the manner described above for the respective characteristic. In another embodiment, it is conceivable to vary more than one or all of the above-mentioned characteristics simultaneously in the manner described above for the respective characteristic, for pushing at least one ion species controlled along said first section of the moving electric field barrier towards said high electric field end of said electric field barrier. In particular, when varying more than one or all of the above-mentioned characteristics simultaneously in the manner described above for the respective characteristic, the respective characteristic can be adapted in a coordinated manner.

In prior art TIMS analyzers, in which one of two axial forces exerting on the ions along the drift length of the ion guide is typically generated using a moving gas, a significant factor in influencing the mobility resolution of the device is the gas velocity with which the ions are moved against the counter-acting DC field barrier. The moving gas results from the pressure difference of the gas pumped out at one end of the TIMS analyzer. Thus, the gas velocity, which is typically in the range of 100 m/s to 200 m/s, can be limited by the pumping speed of commercially reasonable pumps, especially in the case of a laterally extended TIMS analyzer (see, e.g., US 2022/0299473 A1 which is incorporated herein by reference in its entirety). However, the electric field barrier, as generated according to the invention, can be moved around the closed loop ion guide with a movement speed configured significantly higher, thus resulting in a correspondingly higher velocity of the ions moving along the drift length of the ion guide. The mobility resolution is substantially proportional to the movement speed at which the electric field barrier is moved around the ion guide. Thus, a significant improvement of the resolution can be achieved by using a moving electric field barrier as an axial force instead of a moving gas.

Using a closed loop geometry, the electric field barrier which is moving, for example repeatedly, cyclically or periodically, around the closed loop ion guide can urge the ions to undergo multiple cycles of the loop. To keep the ion species within the electric field barrier, or in other words to prevent single ion species to slip over the electric field barrier while moving the electric field barrier with a defined movement speed, a certain electric field strength is needed, which increases with increasing movement speed of the electric field barrier.

Moving the electric field barrier, ions with different ion mobilities will be accumulated at individual balanced positions (equilibrium points) of the moving electric field barrier. In other words, ions with different ion mobility are dynamically balanced in an electric field of suitable strength on the moving electric field barrier. Thus, the ions are separated according to their ion mobility. As the mobility of the ions is proportional to a pressure and inversely proportional to a temperature of the gas through which the ions pass, these individual points of equilibrium depend on these characteristics of the gas. The ions are trapped at these individual relative positions as long as a movement speed and an electric field strength of the moving electric field barrier, as well as a pressure and temperature of the gas through which the ions pass remains constant. By varying an operating parameter which has an impact on the mobility separation, in particular by increasing the movement speed of the electric field barrier and/or decreasing the electric field strength of the moving electric field barrier and/or increasing a pressure of the gas through which the ions pass and/or decreasing a temperature of the gas through which the ions pass as a function of time while moving the electric field barrier around the closed loop ion guide, the separated ion species can be pushed controlled along the moving electric field barrier and can be ejected subsequently. The combination of a high velocity of the ions passing the ion guide and a controlled variation of movement speed and/or electric field strength of the moving electric field barrier and/or pressure and/or temperature of the gas through which the ions pass, allows to improve the mobility resolution by factors.

Compared to prior art TIMS devices and methods, the mbTIMS method and device according to the present invention can be operated with a gas substantially at rest, whereas in prior art TIMS analyzers an axial force exerting on the ions is typically generated using a moving gas. Operating with a gas at rest gives a number of advantages over the prior art TIMS. For example, a laminar flow of gas through the analyzer, as it is present in prior art TIMS, develops a parabolic flow profile. Thus, the flow, and the consequent force on the ions near a lateral boundary of the analyzer will be lower than near the axis of the device. Since the ions always have a certain spatial expansion due to diffusion and space charge repulsion, a portion of them does not experience the highest gas velocity in the center which leads to a reduced resolution. Operating with a gas at rest will lead to a reduced radial dependence on equilibrium positions of the ions and thus to a higher resolution. Another advantage of using a gas at rest is, that there is no axial pressure, velocity and temperature difference within the ion guide, making it easier to generate the moving electric field within the ion guide (or the potential profile along the drift length of the ion guide) as desired. Further, the lateral cross section and length of a TIMS will necessarily determine its gas conductivity. Thus, the lateral dimensions and length of a prior art TIMS analyzer which uses an axial gas flow as axial force will be limited by the pumping speed of commercially reasonable pumps. The advantage of a mbTIMS operated with a gas at rest is that a lateral extension of the device does not affect or limit its resolution. Finally, operating with a gas at rest leads to the effect, that substantially no gas flows out of the mbTIMS. This offers the advantage that more cost expensive gases, like Helium, which is beneficial to separate small ion species and to reduce ion heating, can also be used.

In the context of the present disclosure the drift length of the ion guide corresponds to a length along a longitudinal axis of the ion guide.

The electric field barrier has a low electric field end and a high electric field end. In the context of the disclosure, the low electric field end may represent a beginning of the electric field barrier and the high electric field end may represent an end of the electric field barrier, towards which the ions are pushed before being ejected from the ion guide. The electric field barrier is moved along the ion guide such that the potential at a specific electrode increases from low potential to high potential for most of the time period and then drops back to the low potential. The variation of one of the operating parameters as a function of time, in particular by increasing the movement speed of the electric field barrier and/or decreasing the electric field strength of the moving electric field barrier and/or increasing a pressure of the gas through which the ions pass and/or decreasing a temperature of the gas through which the ions pass, can be step-wisely, continuously or quasi continuously. In particular, the electric field barrier must not rise monotonously in its electric field strength between the low electric field end and the high electric field end.

In the context of the present disclosure “slipping over the moving electric field barrier” is to be understood as that the ions do not re-enter into the moving electric field barrier. Due to the closed circuit, the end (represented as the high electric field end) of the moving electric field barrier is spatially followed by the beginning (represented as the low electric field end) of the electric field gradient of the moving electric field barrier again. Thus, ions not being ejected from the ion guide before slipping over the moving electric field barrier would re-enter the moving electric field barrier again, which would lead to an undesired intermixing of ion species.

In a preferred embodiment said moving electric field barrier comprises a second section represented by a plateau with a substantially constant electric field. Said second section is spatially adjacent to said high electric field end of said electric field gradient. Providing a plateau with a substantially constant electric field spatially adjacent to said high electric field end of said electric field gradient allows to further increase the mobility resolution of the mbTIMS. In particular, this can be achieved by the fact that an ion species which reaches the second section increases its speed of movement while the movement speed of electric field barrier is increased in time and/or while the electric field strength of the moving electric field barrier is decreased and/or while a pressure of the gas through which the ions pass is increased and/or while a temperature of the gas through which the ions pass is decreased in time, resulting in an improved spatial separation for that ion species from the spatially following ion species, as being crossed over to the second section.

In another preferred embodiment said moving electric field barrier is formed along substantially the entire drift length of said ion guide. In doing so, the largest possible volume of the ion guide can be used which reduces the effect of space charge for achieving a better mobility separation.

In another preferred embodiment said moving electric field barrier is formed within one portion of the drift length of said ion guide. This provides the possibility that multiple electric field barriers could be formed within said ion guide, which together take up the entire length of said ion guide.

In another preferred embodiment one or more additional moving electric field barriers are formed within said ion guide. Said moving electric field barriers are formed in sequence along said drift length of said ion guide. Preferably, each of said additional moving electric field barriers comprise a first section represented by an electric field gradient, and a second section represented by a plateau with a substantially constant electric field. Said second section is spatially adjacent to a high electric field end of the electric field gradient. The use of multiple electric field barriers can further increase the mobility resolution of the mbTIMS due to the following reason: To keep the ion species at the plateau, or in other words to prevent certain single ion species to slip over the electric field barrier while moving the electric field barrier with a defined velocity, a certain electric field strength is needed, which increases with increasing moving speed of the electric field barrier. The electric field strength results from the potentials applied to the electrodes, but also depends on the distance between the electrodes. With unchanged applied potentials, if the distance between the electrodes becomes smaller, the resulting electric field strength becomes higher. Due to a risk of hazardous electrical discharges to the surrounding areas, the value of the voltage that can be applied is limited. Providing more than one electric field barriers within the drift length of the ion guide, however, leads in a beneficial manner to the fact that for each individual electric field barrier a lower voltage is necessary to get the same field strength as for a single electric field barrier that is formed over the whole drift length of the ion guide, because of the smaller spatial extension of the single multiple electric field barriers within the ion guide. Due to the possible higher electric field strength, a higher velocity can be chosen to move the multiple electric field barriers, which can further improve the mobility resolution, as the mobility resolution is substantially proportional to the movement speed at which the electric field barrier is moved around the ion guide. Thus, the use of multiple electric field barriers per single loop enables a high field strength at moderate voltages, a higher velocity at moderate voltages and accordingly a higher resolution at moderate voltages. Another advantage is the fact that by using two moving electric field barriers a tandem IMS can be provided in a single device.

In another preferred embodiment one or more additional ion exit regions are provided at least temporally in said ion guide. Preferably the number of ion exit regions is corresponding to the number of said moving electric field barriers and each of said moving electric field barriers is assigned with one of said ion exit regions. Providing an ion exit region for each of said moving electric field barriers allows to eject ions that have reached the end of the respective electric field barriers at a time before slipping over the respective moving electric field barrier.

In another preferred embodiment to cause said axial force transient electric direct current (DC) potentials are applied to said electrodes to generate a transient axial direct current field (DC field). Forming the electric field barrier by applying DC potentials to the electrodes, the ions can be separated according to ion mobility along the electric field barrier.

In another preferred embodiment said transient electric direct current (DC) potentials applied to said electrodes are provided by a plurality of DC voltage generators which generate time-dependent voltages each, wherein each of said electrodes is connected to a separate one of said DC voltage generators. In this way, individual electrodes can be supplied with different potentials for forming the electric field barrier. The temporal potential profiles applied to the electrodes over time can be equal for every electrode along the drift length of the ion guide, wherein along the drift length of the ion guide the temporal potential profiles are applied with a gradual time offset (gradual time delay) to subsequent central electrodes, thus causing the movement of the electric field barrier along the drift length of the ion guide. For an embodiment with one barrier per loop the time delay between adjacent electrodes equals to the time period (a time period is the length of the closed loop divided by the velocity of the moving field barrier) divided by the number of electrodes. It will be understood, however, by a person skilled in the art, that in the context of the invention the aforementioned plurality of (DC voltage) generators can also be understood as a common electrical component with different electrical units.

It is also conceivable that to cause said axial force electric alternating current (AC) potentials are applied to said electrodes to generate an axial alternating current field (AC field), wherein an average of the applied alternating current (AC) voltages changes in space and time forming a transient effective potential. Forming the electric field barrier by applying AC potentials to the electrodes, the ions can be separated according to combination of ion mobility and mass along the electric field barrier.

In another preferred embodiment the ions are injected into said ion guide at an ion entrance region extending over the electrodes along substantially the entire length of said ion guide. Alternatively, the ions are injected into said ion guide at an ion entrance region being provided at fixed specific electrodes in one or more portions of said ion guide.

In another preferred embodiment the ions are ejected from said ion guide at an ion exit region that is provided adjacent to said high electric field end of said moving electric field barrier and moved with said moving electric field barrier such that the ions are ejected continuously in time when reaching said high electric field end of said moving electric field barrier. In case of an electric field barrier comprising solely the first section, represented by the electric field gradient, said high electric field end of said moving electric field barrier corresponds to a high electric field end of said electric field gradient. In case of an electric field barrier comprising the first section, represented by the electric field gradient, and the second section, represented by the plateau with a substantially constant electric field, said high electric field end of said moving electric field barrier corresponds to the end of said plateau of said moving electric field barrier. Providing an ion exit region moving with said moving electric field barrier allows to determine the time of ejecting the ions from the ion guide more precisely. Alternatively, the ions are ejected from said ion guide at an ion exit region that is provided at least temporally at fixed specific electrodes in one or more portions of said ion guide such that the ions are ejected at said specific electrodes. In particular, the ions can be ejected from said ion guide at said fixed specific electrodes when said high electric field end of said moving electric field barrier passes said fixed specific electrodes. Thus, the ion exit region can be provided timed. In particular that means, that the ion exit region can be provided at the ejection electrodes solely at that time, when the end of the electric field barrier is passing the ejection electrodes. In this way an uncontrolled ejection can be prevented, since ions that would not yet have reached the high electric field end of the electric field barrier would also be ejected when passing an untimed ion exit region. Said high electric field end of said moving electric field barrier can be defined as discussed above. In case of a plurality of ion exit regions, each assigned to one of a plurality of electric field barriers, the above described alternatives are equally possible embodiments.

In another preferred embodiment a potential barrier is provided adjacent to said high electric field end of said moving electric field barrier for preventing ions from slipping over said moving electric field barrier before ejecting. In particular, providing a potential barrier adjacent to the high electric field end of said moving electric field barrier is reasonable if the ion exit region is provided temporally at fixed specific electrodes. In this way, the ions can be held in a beneficial manner at the high electric field end of the electric field barrier until they reach the ion exit region.

In another preferred embodiment the ions are injected into said ion guide or ejected from said ion guide in a radial direction through a side of said ion guide.

In another preferred embodiment the ions are injected into said ion guide or ejected from said ion guide in an axial direction, through a top or a bottom of said ion guide.

In another preferred embodiment an ion channel is provided, wherein said ion channel directs ions to be injected into said ion guide towards said ion guide or forwards ions that are ejected from said ion guide. In particular, ions to be injected are directed by said ion channel into said ion guide, or ions that are ejected from said ion guide are forwarded by said ion channel.

For preventing the ions from escaping said ion guide laterally at least some of the electrodes are supplied at least temporally with confining voltages. In doing so, ion loss due to lateral diffusion is reduced and ion transport efficiency is improved. The confining voltages can be provided by the aforementioned generator or by one or more separate generators. It will be understood, however, by a person skilled in the art, that in the context of the invention such a plurality of generators can also be understood as a common electrical component with different electrical units. The confinement field generated in this way can be superimposed on the moving electric field barrier. The ions can be confined by DC potentials (DC confinement) or by a RF pseudopotential (RF confinement) or a combination thereof; depending on the pressure conditions within the ion guide atmospheric pressure ion confinement (APIC) can be used instead of RF confinement, see US 2022/0057363 A1 which is incorporated herein by reference in its entirety). In a preferred embodiment, in a lateral direction, in which the dimension of the ion guide is limited by the central electrodes, the ions can be confined by a RF pseudopotential. In another preferred embodiment, in a lateral direction, in which the dimension of the ion guide is limited by the side electrodes, the ions can be confined by DC potentials. In particular, in that preferred embodiment, prior to ejection, direct current (DC) potentials are applied to said electrodes of said ion guide such that a lateral electric field is generated keeping the ions within said ion guide, and during ejection, direct current (DC) potentials applied to the electrodes are adjusted in said section of said ion guide providing said ion exit region to eject the ions laterally.

In another preferred embodiment said electric field barrier is moved with a velocity of less than 1000 m/s, preferably less than 750 m/s, most preferably less than 500 m/s. The velocity (or movement speed) at which the electric field barrier is moved around the ion guide is substantially proportional to the resolution of the ion mobility. That means, increasing a moving speed advantageously leads to an increased mobility resolution. However, increasing the moving speed leads to an increase of the effective ion temperature. Therefore, there is trade-off between resolution and heating of the ions.

In another preferred embodiment as said gas through which the ions pass one of nitrogen (N), helium (He), neon (Ne), argon (Ar), sulfur hexafluoride (SF₆), hydrogen (H), or air is used. Helium, for example, has a small molecular mass and is therefore beneficial to separate lower mass ion species (especially below 200 Da) according to mobility. Further, Helium is beneficial to reduce ion heating. Alternatively, mixtures of these gases may be used. The use of other gases or mixtures of or with any other gases than those mentioned above is conceivable. Optionally, modifiers may be introduced into the gas. Modifiers may include acetonitrile, methanol, small hydro-carbons, or any other vapor.

The method may be performed in a trapped ion mobility separator, in particular a moving barrier trapped ion mobility separator (mbTIMS). Preferably the method may be performed in a mass spectrometric system.

In a second aspect the invention provides a trapped ion mobility separator comprising:
an ion guide extending in a closed loop, comprising at least one ion entrance region at which ions are injected into said ion guide, and comprising at least one ion exit region at which ions are ejected from said ion guide, said ion guide containing a gas which is substantially at rest and through which the ions pass along a drift length of said ion guide, and said ion guide comprising a plurality of electrodes shaped and arranged to guide the ions along said drift length of said ion guide, wherein at least some of the electrodes are supplied at least temporally with confining potentials for preventing the ions from escaping said ion guide laterally,
at least one generator that causes an axial force to be exerted on the ions along said drift length of said ion guide by applying potentials to the electrodes for forming at least one electric field barrier within said ion guide that has a low electric field end and a high electric field end and that moves, for example repeatedly, cyclically or periodically, around said closed loop ion guide, wherein the moving electric field barrier comprises at least a first section represented by an electric field gradient, and wherein the moving electric field barrier urges the ions to move along said drift length of said ion guide whereby the ions are separated according to their ion mobility along said electric field barrier,
an electrical controller which communicates with said generator to vary at least one operating parameter of the trapped ion mobility separator, which has an impact on the mobility separation, as a function of time while moving said electric field barrier around said closed loop ion guide for pushing at least one ion species controlled along said first section of the moving electric field barrier towards said high potential end, wherein the at least one ion species is ejected laterally from said ion guide in said ion exit region before slipping over said electric field barrier.

The aforementioned trapped ion mobility separator according to the invention is named as moving barrier trapped ion mobility separator (mbTIMS). The moving barrier trapped ion mobility separator can be part of a mass spectrometric system. In particular, the aforementioned method for separating ions can be performed in the moving barrier trapped ion mobility separator.

In a preferred embodiment to vary at least one operating parameter, which has an impact on the mobility separation, comprises at least one of the characteristics of (i) increasing a movement speed of said electric field barrier, (ii) decreasing the electric field strength of said moving electric field barrier, (iii) increasing a pressure of said gas through which the ions pass, and (iv) decreasing a temperature of said gas through which the ions pass. Preferably, to vary at least one operating parameter comprises varying exclusively one of the aforementioned characteristics in the manner described above for the respective characteristic. In another embodiment, it is conceivable to vary more than one or all of the above-mentioned characteristics simultaneously in the manner described above for the respective characteristic, for pushing at least one ion species controlled along said first section of the moving electric field barrier towards said high electric field end of said electric field barrier. In particular, when varying more than one or all of the above-mentioned characteristics simultaneously in the manner described above for the respective characteristic, the respective characteristics can be adapted in a coordinated manner.

In a preferred embodiment said generator is set up to apply potentials to said electrodes such that a plateau with a substantially constant electric field is formed adjacent to said high electric field end of said electric field gradient, representing a second section of said moving electric field barrier. Forming a plateau with a substantially constant electric field spatially adjacent to said high electric field end of said electric field gradient allows to further increase the mobility resolution. In particular, this is achieved by the fact that an ion species which reaches the second section increases its speed of movement while the movement speed of electric field barrier is increased in time and/or while the electric field strength of the moving electric field barrier is decreased and/or while a pressure of the gas through which the ions pass is increased and/or while a temperature of the gas through which the ions pass is decreased in time, resulting in an improved spatial separation for that ion species being crossed over to the second section.

In another preferred embodiment said generator is set up to apply potentials to said electrodes such that one or more additional electric field barriers are formed within said ion guide. Preferably, said additional electric field barriers correspond to the first electric field barrier in their structure and are arranged in sequence along said drift length of said ion guide. In particular, together, the plurality of formed electric field barriers may extend over the entire drift length of the ion guide. The use of multiple electric field barriers can further increase the mobility resolution as described in the context of the method according to the invention, describing an embodiment forming one or more additional moving electric field barriers within said ion guide. In particular, the use of two moving electric field barriers allows to provide a tandem IMS in a single device.

In another preferred embodiment the trapped ion mobility separator comprises a plurality of generators, each being DC voltage generators. The number of DC voltage generators is corresponding to the number of said electrodes forming said closed loop ion guide. Each of said electrodes is assigned with one of said DC voltage generators. In particular, pairs of electrodes can be assigned with one of said DC voltage generators each. In this way, individual electrodes can be supplied with different voltages for forming the electric field barrier. Forming the electric field barrier by applying DC potentials to the electrodes, the ions can be separated according to ion mobility along the electric field barrier. The temporal potential profiles applied to the electrodes over time can be equal for every electrode along the drift length of the ion guide, wherein along the drift length of the ion guide the temporal potential profiles are applied with a gradual time offset (gradual time delay) to subsequent central electrodes, thus causing the movement of the electric field barrier along the drift length of the ion guide. For an embodiment with one barrier per loop the time delay between adjacent electrodes equals to the time period (a time period is the length of the closed loop divided by the velocity of the moving field barrier) divided by the number of electrodes. It will be understood, however, by a person skilled in the art, that in the context of the invention the aforementioned plurality of generators can also be understood as a common electrical component with different electrical units.

It is also conceivable, that said generator is an AC voltage generator, applying voltages to said electrodes to generate an axial alternating current field (AC field) for forming said electric field barrier, wherein an average of the applied alternating current (AC) voltages changes in space and time for forming a transient effective potential. Forming the electric field barrier by applying AC potentials to the electrodes, the ions can be separated according to a combination of ion mobility and mass along the electric field barrier.

In another preferred embodiment said electrodes are arranged such that said ion guide has a substantially circular shape or an elliptical shape. Alternatively, said electrodes are arranged such that said ion guide has a an “8”-like shape. Preferably in said ‘8’-like shape trajectories of the ions moving along said ion guide do not cross but extend at least partly in different planes. Any other closed loop geometry is conceivable, e.g., stadium shaped.

The ion guide, comprising the plurality of electrodes, may comprise 50 to 200 electrodes, preferably 80 to 120 electrodes, more preferably about 100 electrodes. In a preferred embodiment said plurality of electrodes comprises apertured electrodes. The apertures can be slotted apertures, through which the ions can be guided. Alternatively or at the same time said plurality of electrodes comprises electrode modules composed of electrode units each. Said apertured electrodes and/or electrode units are preferably shaped and/or arranged such that said ion guide has a substantially convex cross section. Said ion guide can have a substantially round cross section. In that embodiment, the apertured electrodes and/or electrode units may be shaped curved. Alternatively, preferably said ion guide has a rectangular cross section. In that embodiment, the apertured electrodes and/or electrode units may be shaped straight, each. The apertured electrodes and/or electrode units can be discrete electrode sheets. Alternatively, the electrode units can be embedded in a surface of a printed circuit board (PCB). The electrode units may comprise pairs of central electrodes and/or pairs of side electrodes. In particular, the pairs of side electrodes may comprise pairs of inner electrodes and pairs of outer electrodes. The central electrodes can be segmented in radial direction wherein the radial segments are supplied with different potentials such that the axial field strength at outer segments is higher than at inner segments in order to achieve an angular velocity which is independent along the radial direction.

In another preferred embodiment the trapped ion mobility separator further comprises an ion channel. Said ion channel comprises an array of electrodes. Said electrodes are set up to direct ions to be injected into said ion guide towards said ion guide. Alternatively or additionally said electrodes are set up to forward ions that are ejected from said ion guide. The trapped ion mobility separator can comprise more than one ion channel, each comprising an array of electrodes. In particular, a first ion channel can comprise an array of electrodes to direct ions to be injected into said ion guide towards said ion guide, and a second ion channel can comprise an array of electrodes to forward ions that are ejected from said ion guide. The array of electrodes can be shaped and arranged as described in the following three paragraphs.

In a first preferred embodiment a rotation axis of said ion channel is substantially coaxial to a rotation axis of said ion guide. The ion channel can extend through a center of the ion guide, wherein the ion channel can be elongated in the z-dimension at a top-side, a bottom-side, or both, a top- and a bottom-side of the ion guide. An area in which the ion guide is located can be omitted. One end of an ion channel, which is elongated in the z-dimension at the top-side of the ion guide, may be coupled to an inner edge of the top-side of the ion guide. One end of an ion channel, which is elongated in the z-dimension at the bottom-side of the ion guide, may be coupled to an inner edge of the bottom-side of the ion guide. It is also conceivable, that the ion channel comprises an inner boundary, representing an inner radius that is coupled to an inner edge of the ion guide, and an outer boundary, representing an outer radius that is coupled to an outer edge of the ion guide, with a gap provided between the outer radius and the inner radius. The gap can represent an annulus, i.e., the difference between the outer radius and the inner radius (ring-shaped space), through which ions can pass. This way of shaping can increase a charge capacity. The array of electrodes may comprise stacked ring electrodes being arranged evenly spaced from each other. The electrodes all may have the same diameter, or may have a decreasing diameter along a direction of extension of the ion guide. Thus, the ion channel may be shaped with a round cross section or as an ion funnel.

In a second preferred embodiment a longitudinal axis of said ion channel is substantially perpendicular to a rotation axis of said ion guide. One end of the ion channel may be coupled to a portion of an outer edge of the ion guide. The array of electrodes may comprise segmented electrodes being arranged evenly spaced from each other. The electrodes may be shaped and arranged such, that the ion channel has a substantially rectangular cross section.

In particular, in a conceivable embodiment the trapped ion mobility separator comprises a first and a second ion channel, wherein a rotation axis of the first ion channel is substantially coaxial to a rotation axis of the ion guide, and a longitudinal axis of the second ion channel is substantially perpendicular to a rotation axis of the ion guide.

In another preferred embodiment the trapped ion mobility separator further comprises an ion trap for storing ions. Said ion trap is located upstream of said ion guide within said ion channel. The ion trap allows in a beneficial manner, that the mbTIMS can be operated in a parallel accumulation mode. That means the ion trap can accumulate ions in an advantageous way, while simultaneously ions can be separated downstream in said ion guide. In particular, the ion trap allows a parallel accumulation mode with a near one hundred percent duty cycle. Preferably, said ion trap can have substantially the same dimensions as said ion channel.

In another preferred embodiment the trapped ion mobility separator further comprises at least a second ion guide. Preferably, the trapped ion mobility separator further comprises a plurality of additional ion guides. Each of the additional ion guides may have the same structure as the aforementioned ion guide. Each of the additional ion guides may be operated in the same mode as the aforementioned ion guide. The ion guides may be arranged sequentially. Further, the ion guides may have a common ion channel, linking the individual ion guides with each other. Combining a plurality of ion guides, a significantly higher storage volume can be achieved, which increases the possible number of ions to be analyzed. Preferably, the electrical controller synchronizes the lateral ejections of one ion species from the additional ion guides.

In another preferred embodiment the trapped ion mobility separator is coupled to a vacuum system that is designed and configured to operate the trapped ion mobility separator at a gas pressure in a range of 0.1 mbar to 20 mbar. Preferably the vacuum system is designed and configured to operate the trapped ion mobility separator at a gas pressure in a range of 2 mbar to 10 mbar. For this purpose, the vacuum system may comprise pumps. A pressure range of 0.1 mbar to 50 mbar allows a lateral ion confinement by using electric RF fields. It is also conceivable, that the vacuum system is designed and configured to operate the trapped ion mobility separator at a gas pressure in a range of more than 50 mbar. However, a pressure range of more than 50 mbar allows a lateral ion confinement only by using atmospheric pressure ion confinement (APIC).

The trapped ion mobility separator according to the invention can be operated as an individual device (or stand-alone device) for measuring the mobility of the ions. Alternatively, it is conceivable that the mbTIMS is coupled with other devices, such as a mass spectrometer (mass analyzer). When coupling a mbTIMS and a mass spectrometer, both the mobility and the mass of the ions can be determined from the measured data.

Preferred embodiments described for the aforementioned method of separating ions are also preferred embodiments of the trapped ion mobility separator according to the invention. The preferred embodiments for the trapped ion mobility separator are also preferred embodiments of the aforementioned method for separating ions.

In a third aspect the invention provides a mass spectrometric system. The mass spectrometric system comprises an ion source and a mass analyzer with an ion detector. Further, mass spectrometric system comprises at least a first trapped ion mobility separator, located downstream of said ion source. At the same time or in an alternative embodiment said first trapped ion mobility separator is located upstream of said mass analyzer. Said first trapped ion mobility separator comprises
an ion guide extending in a closed loop, comprising at least one ion entrance region at which ions are injected into said ion guide, and comprising at least one ion exit region at which ions are ejected from said ion guide, said ion guide containing a gas which is substantially at rest and through which the ions pass along a drift length of said ion guide, and said ion guide comprising a plurality of electrodes shaped and arranged to guide the ions along said drift length of said ion guide, wherein at least some of the electrodes are supplied at least temporally with confining potentials for preventing the ions from escaping said ion guide laterally,
at least one generator that causes an axial force to be exerted on the ions along said drift length of said ion guide by applying potentials to the electrodes for forming at least one electric field barrier within said ion guide that has a low electric field end and a high electric field end and that moves, for example repeatedly, cyclically or periodically, around said closed loop ion guide, wherein the moving electric field barrier comprises at least a first section represented by an electric field gradient, and wherein the moving electric field barrier urges the ions to move along said drift length of said ion guide whereby the ions are separated according to their ion mobility along said electric field barrier,
an electrical controller which communicates with said generator to vary at least one operating parameter of the trapped ion mobility separator, which has an impact on the mobility separation, as a function of time while moving said electric field barrier around said closed loop ion guide for pushing at least one ion species controlled along said first section of the moving electric field barrier towards said high potential end, wherein the at least one ion species is ejected laterally from said ion guide in said ion exit region before slipping over said electric field barrier.

Thus, the above-described trapped ion mobility separator can be part of a hybrid mass spectrometric system, comprising additionally at least an ion source upstream of said trapped ion mobility separator and a mass analyzer with an ion detector downstream of said trapped ion mobility separator. The above-described trapped ion mobility separator according to the invention is named as moving barrier trapped ion mobility separator (mbTIMS).

The ion source of the mass spectrometric system is set up to generate ions. For example, said ion source of the mass spectrometric system can generate ions using spray ionization (e.g., electrospray (ESI) or thermal spray). Alternatively, said ion source of the mass spectrometric system can generate ions using desorption ionization (e.g., matrix-assisted laser/desorption ionization (MALDI) or secondary ionization (SIMS)). In another alternative, said ion source of the mass spectrometric system can generate ions using chemical ionization (CI). In another alternative, said ion source of the mass spectrometric system can generate ions using photo-ionization (PI). In another alternative, said ion source of the mass spectrometric system can generate ions using electron impact ionization (EI). In another alternative, said ion source of the mass spectrometric system can generate ions using gas-discharge ionization.

The mass analyzer of the mass spectrometric system is set up to analyze ions according to their mass or more precisely mass to charge ratio. For example, said mass analyzer can be a time-of-flight analyzer. Preferably said mass analyzer can be a time-of-flight analyzer with orthogonal injection of ions. Alternatively, said mass analyzer can be an electrostatic ion trap of the Kingdon type, such as the Orbitrap® from Thermo Fisher Scientific. In another alternative, said mass analyzer can be an RF ion trap. In another alternative, said mass analyzer can be an ion cyclotron resonance (ICR) ion trap or a quadrupole mass filter.

In a preferred embodiment to vary at least one operating parameter comprises at least one of the characteristics of (i) increasing a movement speed of said electric field barrier, (ii) decreasing the electric field strength of said moving electric field barrier, (iii) increasing a pressure of said gas through which the ions pass, and (iv) decreasing a temperature of said gas through which the ions pass. Preferably, to vary at least one operating parameter comprises varying exclusively one of the aforementioned characteristics in the manner described above for the respective characteristic. In another embodiment, it is conceivable to vary more than one or all of the above-mentioned characteristics simultaneously in the manner described above for the respective characteristic, for pushing at least one ion species controlled along said first section of the moving electric field barrier towards said high electric field end of said electric field barrier. In particular, when varying more than one or all of the above-mentioned characteristics simultaneously in the manner described above for the respective characteristic, the respective characteristics can be adapted in a coordinated manner.

In a preferred embodiment the mass spectrometric system further comprises a second ion mobility separator, preferably a trapped ion mobility separator. Preferably, said second ion mobility separator is located downstream of said first trapped ion mobility separator. Said second ion mobility separator can be another ion mobility separator according to the invention. Alternatively, said second ion mobility separator can be a trapped ion mobility separator constructed and operated to disperse ions according to ion mobility, preferably in the low field limit. Alternatively, said second ion mobility separator can be a differential trapped ion mobility separator (dTIMS), separating ions according to their differential mobility (see the provisional US application having the application No. 63/510,706 which is incorporated herein by reference in its entirety). Said first trapped ion mobility separator and said second ion mobility separator can be nested coupled, i.e. that the first trapped ion mobility separator operates on a substantially larger time scale than the second ion mobility separator such that the second ion mobility separator can analyze single ion species separated by the first trapped ion mobility separator or each fraction provided by the first trapped ion mobility separator.

It is conceivable, that in another preferred embodiment the mass spectrometric system further may comprise a first housing assigned to the first trapped ion mobility separator. In particular, the first housing may enclose the first trapped ion mobility separator. Additionally, the mass spectrometric system may comprise a second housing assigned to the second ion mobility separator. In particular, the second housing may enclose the second ion mobility separator. The first housing and the second housing may represent a vacuum chamber each. The first housing and the second housing may maintain the gas atmosphere within the trapped ion mobility separators each. The gas assigned to the first ion mobility separator can differ from the gas assigned to the second ion mobility separator. Using different gases within the first and second trapped ion mobility separators enables in an advantageous way, that ions which may not be sufficiently separated within the first ion mobility separator may be separated within the second ion mobility separator, as the type of gas has an effect on the drift velocity of the ions.

In a preferred embodiment the mass spectrometric system further comprises a fragmentation cell. The fragmentation cell is set up to dissociate ions into fragment ions. Preferably, said fragmentation cell is located between said first trapped ion mobility separator and said mass analyzer. It is also conceivable, that the fragmentation cell is located between said first trapped ion mobility separator and said second trapped ion mobility separator. For example, the ions can be dissociated in said fragmentation cell by collision induced dissociation (CID). Alternatively, the ions can be dissociated in said fragmentation cell by surface induced dissociation (SID). In another alternative, the ions can be dissociated in said fragmentation cell by photo-dissociation (PD). In another alternative, the ions can be dissociated in said fragmentation cell by electron-induced dissociation, such as electron capture dissociation (ECD), electron transfer dissociation (ETD), collisional activation after electron transfer dissociation (ETcD), or activation concurrent with electron transfer dissociation (AI-ETD). In another alternative, the ions can be dissociated in said fragmentation cell by reactions with highly excited or radical neutral particles.

In another preferred embodiment the mass spectrometric system further comprises a mass filter, such as an RF rod quadrupole. Preferably, said mass filter is located between said first trapped ion mobility separator and said fragmentation cell.

In another preferred embodiment, the mass spectrometric system further comprises at least one ion trap. The ion trap is set up to store ions. Preferably, a first ion trap is located upstream of said first trapped ion mobility separator. In addition, or alternatively a second ion trap can be located between said first trapped ion mobility separator and said second ion mobility separator.

Furthermore, the mass spectrometric system can comprise a separation device. Said separation device can be a gas chromatography device. Alternatively, said separation device can be a liquid chromatography device. It is also conceivable that the mass spectrometric system further comprises an electrophoretic device. Alternatively, an electrophoretic device can be coupled to the hybrid mass spectrometric system.

The preferred embodiments described for the aforementioned method of separating ions and for the aforementioned trapped ion mobility separator are also preferred embodiments of the mass spectrometric system. The preferred embodiments for the mass spectrometric system, which refer to the trapped ion mobility separator are also preferred embodiments of the aforementioned trapped ion mobility separator.

### BRIEF DESCRIPTION OF THE DRAWINGS

The invention can be better understood by referring to the following figures. The elements in the figures are not necessarily to scale, emphasis instead being placed upon illustrating the principles of the invention (often schematically):

FIG. 1a shows a schematic perspective view of a first embodiment of a trapped ion mobility separator according to the invention,

FIG. 1b shows a schematic cross-sectional view of the first embodiment of a trapped ion mobility separator,

FIG. 2 presents a spatial profile of the potential applied to the central electrodes along the drift length of the ion guide,

FIG. 3 presents a spatial profile of the potential applied to the side electrodes along the drift length of the ion guide,

FIG. 4 presents a temporal profile of the potential applied to a single pair of central electrodes over time,

FIG. 5 presents a spatial profile of the potential applied to the central electrodes along the drift length of the ion guide in a second optional mode of operating the trapped ion mobility separator from FIG. 1,

FIG. 6a shows a trapped ion mobility separator like that of FIGS. 1a and 1b in a third optional mode of operation,

FIG. 6b represents a temporal profile of the potential applied to the driving/collecting electrodes over the time of a single moving cycle of the electric field barrier in the third optional mode of operation,

FIG. 6c represents a temporal profile of the potential applied to the ejection electrodes over the time of a single moving cycle of the electric field barrier in the third optional mode of operation,

FIG. 7 shows a schematic perspective view of a second embodiment of a trapped ion mobility separator according to the invention,

FIG. 8 shows a schematic perspective view of a third embodiment of a trapped ion mobility separator according to the invention,

FIG. 9 shows a schematic perspective view of a fourth embodiment of a trapped ion mobility separator according to the invention,

FIG. 10 shows a schematic perspective view of a fifth embodiment of a trapped ion mobility separator according to the invention,

FIG. 11 shows a schematic perspective view of a sixth embodiment of a trapped ion mobility separator according to the invention,

FIG. 12 shows a schematic diagram of a mass spectrometric system according to the invention.

### DETAILED DESCRIPTION

While the invention has been shown and described with reference to a number of different embodiments thereof, it will be recognized by those skilled in the art that various changes in form and detail may be made herein without departing from the scope of the invention as defined by the appended claims.

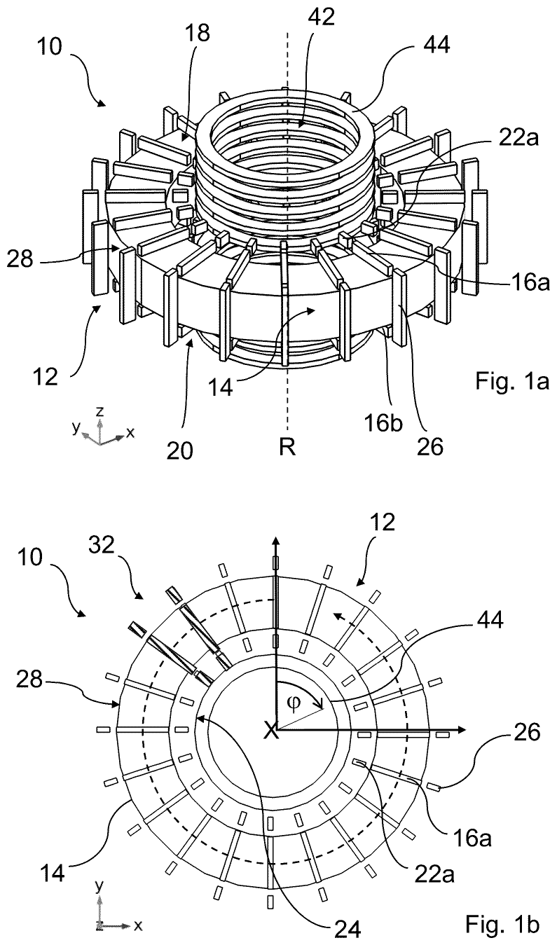

FIG. 1a shows a schematic perspective view of a first embodiment of a trapped ion mobility separator 10 according to the invention, and FIG. 1b shows a schematic cross sectional view of the first embodiment of a trapped ion mobility separator 10 in z-direction. Thus, the trapped ion mobility separator 10 is a moving barrier trapped ion mobility separator (mbTIMS). The trapped ion mobility separator 10 is used to trap and separate ions according to their mobility. In particular, the trapped ion mobility separator 10 may be part of a mass spectrometric system. For a better overview, coordinate systems are included in FIG. 1, in particular representing the circle angle q.

The trapped ion mobility separator 10 comprises an ion guide 12. The ion guide 12 contains a gas which is substantially at rest and through which the ions pass along a drift length 14 in the direction of the dotted drawn arrow (FIG. 1b) of the ion guide 12. In the embodiment example, the gas contained in the ion guide 12 is Helium.

The ion guide 12 comprises a plurality of electrodes shaped and arranged to guide the ions along the drift length 14 of the ion guide 12. In the embodiment example the ion guide 12 comprises one hundred electrodes, wherein each electrode is composed of electrode units, with a first electrode unit and a second electrode unit each. The first electrode unit comprises a pair of central electrodes, with a first central electrode 16a arranged on a top-side 18 of the ion guide 12, and with a second central electrode 16b arranged on a bottom-side 20 of the ion guide 12. For a better overview just one of the central electrodes 16a, 16b are provided with a reference sign each. The second electrode unit comprises a pair of side electrodes, with an inner electrode, segmented into two segments, of which only segment 22a is shown in the figure, arranged on a first side 24 of the ion guide 12 facing to a center (marked with an “X” in the FIG. 1b) of the ion guide 12, and with an outer electrode 26, arranged on a second side 28 of the ion guide 12, facing away from the center of the ion guide 12. Again, for a better overview just one of the inner and outer electrodes 22a, 26 are provided with a reference sign each. The electrode units are discrete electrode sheets, each. In the embodiment example, the electrode units are arranged such that the ion guide 12 has a continuous circular shape and a substantially rectangular cross section along the drift length 14 of the ion guide 12.

Further, the ion guide 12 provides an ion entrance region at the inner side 24. The ion entrance region is set up to allow ions to be injected from the ion channel 42 into the ion guide 12.

Further, the ion guide provides an ion exit region 32 which is set up to allow ions to be ejected from the ion guide 12. In the embodiment example, the ion exit region 32, which is marked exemplarily by hatched electrodes, is moved periodically around the closed loop ion guide 12.

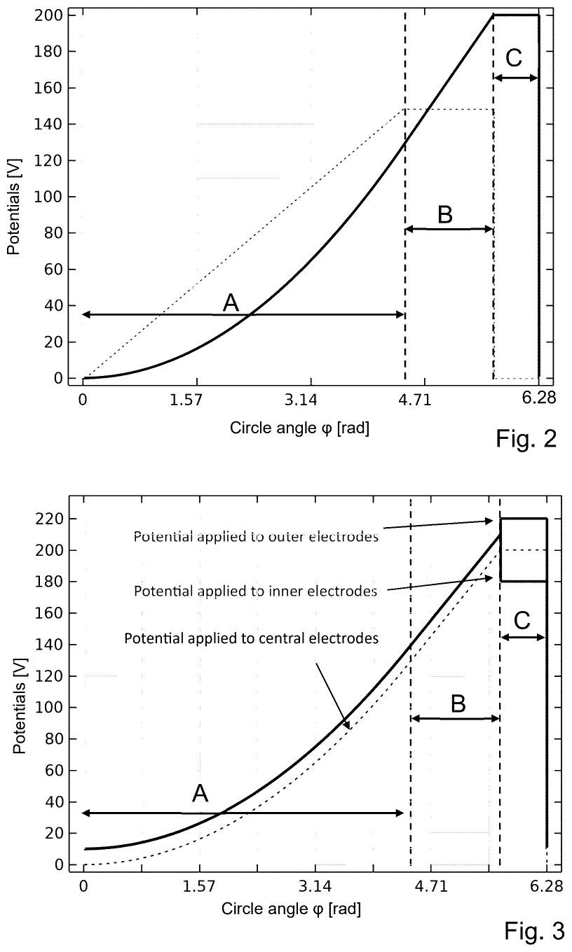

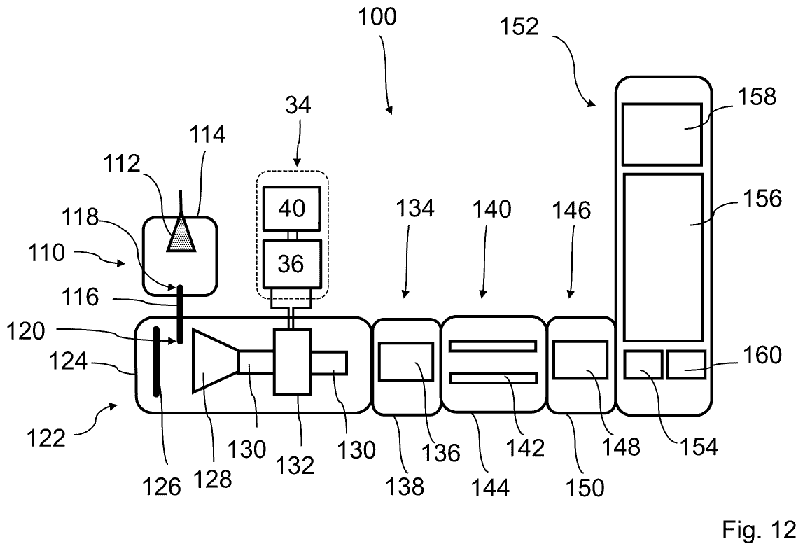

The trapped ion mobility separator 10 comprises an electrical component 34 (FIG. 12). In the embodiment example, the electrical component 34 comprises a plurality of electrical units, each being DC voltage generators 36. The generators 36 cause an axial force to be exerted on the ions along the drift length 14 of the ion guide 12. To cause the axial force, in the embodiment example, the generators 36 apply potentials to the electrodes for forming an electric field barrier with a low electric field end and a high electric field end within the ion guide 12, that moves periodically around the closed loop ion guide 12. In the embodiment example, the moving electric field barrier comprises a first section (A) represented by an electric field gradient, and a second section (B) represented by a plateau with a substantially constant electric field, which is spatially adjacent to a high electric field end of the electric field gradient (cf. FIG. 2). The axial force has an effect on the movement of the ions that is dependent on mobility by virtue of its interplay with the gas.

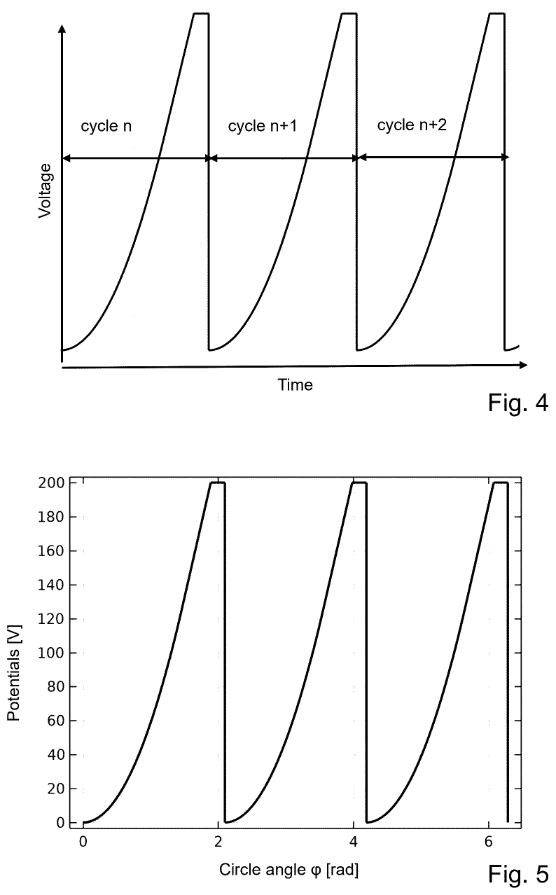

In particular, the generators 36 are set up to generate time-dependent voltages to be applied to one pair of central electrodes each, wherein the voltage is changed for every new time interval as shown with reference to FIG. 4. The number of generators 36 corresponds to the number of pairs of central electrodes, wherein each pair of central electrodes is assigned with one separate generator 36.

The trapped ion mobility separator 10 comprises an electrical controller 40 (FIG. 12). The electrical controller 40 communicates with the generators 36. The electrical controller 40 is set up to increase a moving speed of the electric field barrier and to decrease the electric field strength of the moving electric field barrier as a function of time while moving the electric field barrier around the closed loop ion guide 12.

Further, the trapped ion mobility separator 10 comprises an ion channel 42. The ion channel 42 comprises an array of electrodes to direct the ions to be injected into the ion guide towards the ion guide 12 and to forward ions that are ejected from the ion guide 12. In the embodiment example the array of electrodes is composed of stacked ring electrodes 44, all having the same diameter and being arranged evenly spaced from each other. For a better overview just one of the ring electrodes 44 is provided with a reference sign. The ion channel 42 extends through the center X of the ion guide 12, wherein the ion channel 42 is elongated in the z-dimension in both an upper and a lower direction with respect to the ion guide 12, omitting the area in which the ion guide 12 is located. In the embodiment example a rotation axis of the ion channel 42 is coaxial to a rotation axis of the ion guide 12 (R; shown as a dotted drawn line).

In the following, the mode of operation of the first embodiment of the trapped ion mobility separator 10 according to the invention is described:

Ions are injected into the ion guide 12. In particular, the ions are directed from the ion channel 42 towards the ion guide 12 to be injected into the ion guide 12. In the embodiment example the ions are injected into the ion guide 12 in a radial direction through the first inner side 24 of the ion guide 12 along substantially the entire drift length 14 of the ion guide 12. To allow this, DC potentials are applied between the inner electrodes and outer electrodes of the ion guide 12 such that a lateral electric field is generated which pulls the ions away from the center X and into the ion guide 12. Subsequently, radially confining DC potentials are applied to the side electrodes for preventing the ions from escaping the ion guide 12 laterally.

Subsequently, an axial force that is imparted to the ions along the drift length 14 of the ion guide 12 is generated by the generators 36 by applying potentials to the pairs of central electrodes to form an electric field barrier within the ion guide 12. In the embodiment example direct current (DC) potentials are applied to the pairs of central electrodes to generate an axial direct current field (DC field). The potentials are applied such that the electric field barrier is formed along substantially an entire drift length 14 of the ion guide 12. Further, the potentials are applied such that the electric field barrier comprises the first section (A) and the second section (B) as described above.

In the embodiment example, the generated electric field barrier is moved periodically around the closed loop ion guide 12. In particular, the generated electric field barrier is moved in that direction in that the electric field of the electric field barrier at a specific position of the ion guide 12 gradually increases from low to high field for most of the time during one time period and then drops back to low field. Moving the electric field barrier, ions with different ion mobilities, which would generally move to the low electric field end of the electric field gradient without the movement, will be accumulated at individual balanced positions (equilibrium points) on the electric field barrier. Or, in other words, the ions with different mobility are dynamically balanced in an electric field of suitable strength on the electric potential profile. Thus, the ions are separated according to their ion mobility. At the same time, the ions are urged by the moving electric field barrier to move along the drift length of the ion guide 12, whereby the ions are trapped at these individual relative positions as long as a moving speed, an electric field strength of the moving electric field barrier, and a pressure and temperature of the gas through which the ions pass remains constant.

At the same time, confinement potentials are applied to the electrodes to prevent the ions from escaping the ion guide laterally. In a lateral direction, in which the dimension of the ion guide 12 is limited by the pairs of side electrodes, the ions are confined by DC potentials as described above and with reference to FIG. 3. In a lateral direction, in which the dimension of the ion guide 12 is limited by the pairs of central electrodes, the ions are confined by a RF pseudopotential.

The axial force is varied over time by the electric controller 40. In the embodiment example, the axial force is varied such that a movement speed of the electric field barrier is increased, and the electric field strength of the moving electric field barrier is decreased as a function of time while moving said electric field barrier around said closed loop ion guide 12. In another conceivable embodiment, alternatively or additionally, a pressure of the gas through which the ions pass in the ion guide 12 could have been increased and/or a temperature of the gas through which the ions pass in the ion guide 12 could have been decreased as a function of time while moving said electric field barrier around said closed loop ion guide 12. In doing so, ion species are pushed along the first section (A) of the moving electric field barrier towards the high electric field end of said electric field barrier, wherein ion species with different ion mobilities subsequently reach the second section (B) of the electric field end. An ion species reaching the second section increases its speed of movement while the movement speed of electric field barrier is increased in time and/or while the electric field strength of the moving electric field barrier is decreased in time. This way an improved spatial separation is given of an ion species being crossed over to the second section.

The ion species having crossed over to the second section are ejected from the ion guide 12 each, before slipping over the electric field barrier. The ions are ejected from the ion guide 12 at the exit region that is moving with the electric field barrier. In the embodiment example the ions are ejected from the ion guide 12 in a radial direction through the first side 24 of the ion guide 12. To allow this, the DC potentials applied between the outer electrodes and inner electrodes of the ion guide 12 are varied such that a lateral electric field is generated which pushes the ions to the center X of the ion guide 12. In particular, in the embodiment example the ion exit region is provided adjacent to the high electric field end of the moving electric field barrier and is moved periodically with the moving electric field barrier such that the ion exit region remains at the high electric field end of the moving electric field barrier and that the ions are ejected continuously in time when reaching the high electric field end of the moving electric field barrier. Subsequently, the ions ejected from the ion guide 12 are forwarded by the ion channel 42 for further analyses.

In the embodiment example, the trapped ion mobility separator 10 is operated at a gas pressure of 5 mbar.

FIG. 2 presents a spatial profile of the potential applied to the pairs of central electrodes along the drift length 14 of the ion guide 12 (solid drawn line). This potential relates to the direct current voltage, causing the axial force as described with reference to FIG. 1. Further, FIG. 2 presents a spatial profile of the generated electric field along the drift length 14 of the ion guide 12 (dotted drawn line). Principally, the electric field is the spatial derivation of the potential. The presented profiles correspond to a state at a point in time “zero”, i.e., the point in time in that applying potentials to the electrodes begins, just before a movement of the electric field barrier around the closed loop ion guide starts.

On the ordinate the potential (V) applied to the pairs of central electrodes is shown, and on the abscissa the circular angle q (rad), representing the extension of the ion guide 12 in its longitudinal direction, is shown. As can be seen in the figure, the electric field barrier is formed along substantially the entire drift length of the ion guide. Further, as can be seen from the figure, the potentials applied to the central electrodes increase quadratically in a first section (A) and increase linearly in a second section (B). Accordingly, an electric field is generated, as claimed in the invention, with an electric field gradient (first section of the electric field barrier) and a plateau with a substantially constant electric field (second section of the electric field barrier), adjacent to a high electric field end of the first section. In an angular range adjacent to the second section, in a third section (C) constant potentials are applied to the central electrodes, leading to the fact that the axial electric field is canceled in this area, thus representing an ion exit region (ejection region).

FIG. 3 presents a spatial profile of the potential applied to the pairs of side electrodes along the drift length 14 of the ion guide 12 (solid drawn line). This potential relates to the direct current voltage, causing the radial DC confinement as described with reference to FIG. 1. Further, for comparison, FIG. 3 presents the profile of the potential applied to the central electrodes along the drift length 14 of the ion guide 12 (dotted drawn line), as shown in FIG. 2. The presented profiles correspond to a state at a point in time “zero”, i.e., the point in time in that applying potentials to the electrodes begins, just before a movement of the electric field barrier around the closed loop ion guide starts.

On the ordinate, the potential (V) applied to the pairs of side electrodes is shown, and on the abscissa the circular angle q (rad), representing the extension of the ion guide 12 in its longitudinal direction, is shown. As can be seen in the figure, in an angular range associated with the first and second section of the electric field barrier, the potentials applied to the inner electrodes and to the outer electrodes are comparable to each other. Further, as can be seen in the figure, in the angular range associated with the first and second section of the electric field barrier, the potentials applied to the side electrodes are comparable with those applied to the central electrodes, but with a small offset to higher potentials in order to confine the ions laterally. In the angular range associated with the ejection region, however, the potentials applied to the inner electrodes, the outer electrodes and the central electrodes differ from each other. In particular, a potential gradient is created between the inner electrodes and the outer electrodes, with a comparatively lower potential applied to the inner electrodes and a comparatively higher potential applied to the outer electrodes, thus leading to a radial ejection of the ions towards a center of the ion guide in the ion exit region (ejection region).

FIG. 4 presents a temporal profile of the potential applied to a single pair of central electrodes over time. As explained with reference to FIG. 1, the electric field barrier is moved periodically around the closed loop ion guide in the direction of the dotted drawn arrow. In the embodiment example the electric field barrier is exemplarily shown to be moved three times around the ion guide 12 (cycle n, cycle n+1, cycle n+2), wherein the temporal profile depicts the changing potential applied to the single pair of central electrodes over time, during the three cycles of movement. In the embodiment example the potentials applied to the single pair of central electrodes are provided by a DC voltage generator 36 which generates time-dependent voltages, changing in their voltage value according to the shown profile. As described with reference to FIG. 1, in the embodiment example, a plurality of additional DC voltage generators 36 are provided (not shown in the figure), where each pair of central electrodes is assigned with a separate one of the generators, which generate time-dependent voltages each. The potentials applied to each of the pairs of central electrodes over time, provided by the generators 36, each corresponds to the shown profile, wherein along the drift length 14 of the ion guide 12 the potential profile over time as shown in the figure is applied with a gradual time offset (gradual time delay) to subsequent pairs of central electrodes, thus causing the movement of the electric field barrier along the drift length 14 of the ion guide 12 as described with reference to FIG. 1 and FIG. 2. The time delay between adjacent electrodes equals to the time period divided by the number of electrodes.

FIG. 5 presents a spatial profile of the potential applied to the pairs of central electrodes along the drift length 14 of the ion guide 12. This potential relates to the direct current voltage, causing the axial force. The presented spatial profile corresponds to a state at a point in time “zero”, i.e., the point in time in that applying potentials to the electrodes begins.

On the ordinate the potential (V) applied to the pairs of central electrodes is shown, and on the abscissa the circular angle q (rad), representing the extension of the ion guide 12 in its longitudinal direction, is shown. As can be seen in the figure, multiple electric field barriers are formed within the drift length 14 of the ion guide 12. In particular, three electric field barriers are formed within the drift length 14 of the ion guide 12, being arranged sequentially. In the embodiment example, each of these electric field barriers corresponds to the single electric field barrier as described with reference to FIG. 2, however, as multiple electric field barriers are formed within the drift length 14 of the ion guide 12, the electric field barriers each have a larger gradient within the first section (A).

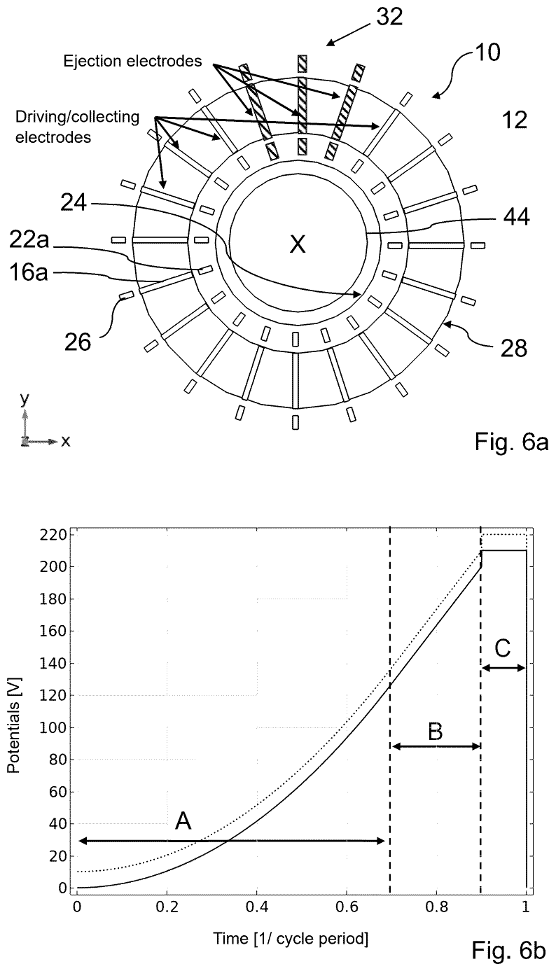

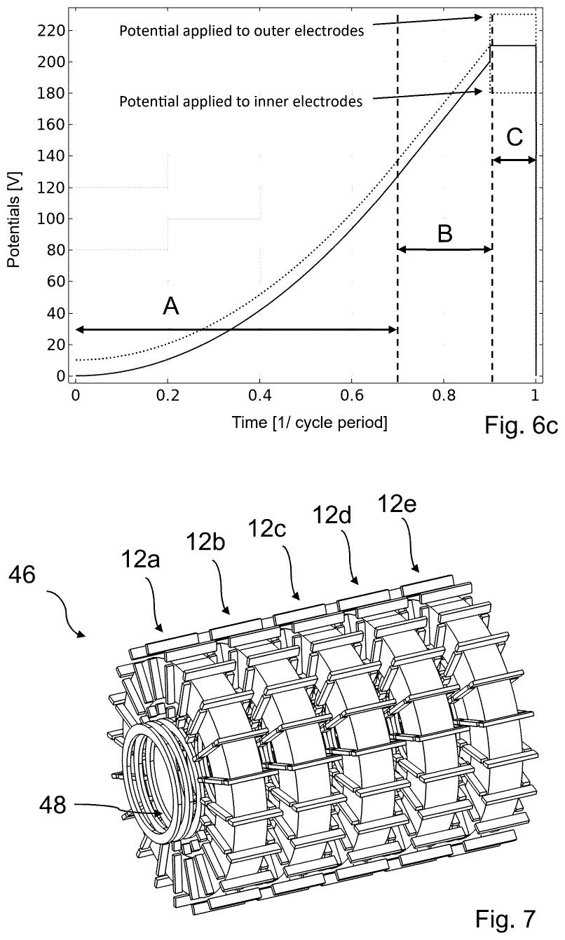

FIGS. 6a to 6c represent a third optional mode of operating the trapped ion mobility separator 10, wherein FIG. 6a shows the trapped ion mobility separator 10 in a cross-sectional view in z-direction, FIG. 6b represents a spatial profile of the potential applied to the driving/collecting electrode, and FIG. 6c represents a profile of the potential applied to the ejection electrodes. The presented profiles correspond to a state at a point in time “zero”, i.e., the point in time in that applying potentials to the electrodes begins, just before a movement of the electric field barrier around the closed loop ion guide starts.

FIG. 6a shows the trapped ion mobility separator 10 in a cross-sectional view in z-direction. The trapped ion mobility separator is operated in a mode, in which the ion exit region 32 (marked by hatched electrodes) is provided at fixed specific electrodes in one portion of the ion guide 12 (stationary ejection region), such that the ions are ejected periodically at that specific electrodes. In the figure, the fixed specific electrodes providing the ion exit region 32 are marked by hatching, in the following named as ejection electrodes in this embodiment example. As described with reference to FIG. 1, the ions are ejected from the ion guide 12 in a radial direction through the first side 24 of the ion guide 12. All the remaining pairs of central electrodes surrounding the ejecting electrodes are named as driving/collecting electrodes in the following description of this embodiment example.

FIG. 6b represents a temporal profile of the potential applied to the driving/collecting electrodes each, over the time of a single moving cycle of the electric field barrier. The solid drawn line represents the potential applied to the pairs of central driving/collecting electrodes, and the dotted drawn line represents the potential applied to the pairs of side driving/collecting electrodes. On the ordinate the potential (V) applied to the pairs of driving/collecting electrodes is shown, and on the abscissa the time (1/cycle period) is shown. As can be seen in the figure, the potential applied to the pairs of driving/collecting electrodes in general corresponds to the potential applied to a single pair of central electrodes over time, as described with reference to FIG. 4, with the difference that (instead of a linear continuation at the end of the second section (B)) a potential barrier is provided adjacent to the second section (B) of the moving electric field barrier for preventing ions from slipping over the moving electric field barrier before ejecting.

FIG. 6c represents a temporal profile of the potential applied to the ejection electrodes over the time of a single moving cycle of the electric field barrier. Again, the solid drawn line represents the potential applied to the pairs of central electrodes, and the dotted drawn line represents the potential applied to the pairs of side electrodes. In the embodiment example the ejection electrodes comprise three pairs of central ejection electrodes and a corresponding number of pairs of side ejection electrodes. On the ordinate the potential (V) applied to the pairs of ejection electrodes is shown, and on the abscissa the time (1/cycle period) is shown. As can be seen in the figure, in a time range associated with the first and second section (A, B) of the electric field barrier the potentials applied to the inner ejection electrodes and to the outer ejection electrodes are comparable to each other. Further, as can be seen in the figure, in the time range associated with the first and second section (A, B) of the electric field barrier the potentials applied to the pairs of side ejection electrodes are comparable with those applied to the pairs of central ejection electrodes, but with a small offset to higher potentials for confining the ions in the direction of the side electrodes. In the time range associated with the ejection region (C), however, the potentials applied to the inner ejection electrodes, the outer ejection electrodes and the central electrodes differ from each other. In particular, a potential gradient is created between the inner ejection electrodes and the outer ejection electrodes, as described with reference to FIG. 3, with a comparatively lower potential applied to the inner ejection electrodes and a comparatively higher potential applied to the outer ejection electrodes, thus leading to a radial ejection of the ions towards a center of the ion guide in the ion exit region 32 (ejection region). Thus, as can be seen in the figure, the ion exit region 32 is provided timed. In particular, that means that the ion exit region 32 is provided at the ejection electrodes solely that time, when the end of the plateau with substantially constant electric field (second section B) is passing the ejection electrodes.

FIG. 7 shows a schematic perspective view of a second embodiment of a trapped ion mobility separator 46 according to the invention. Thus, the trapped ion mobility separator 46 is a moving barrier trapped ion mobility separator (mbTIMS). The trapped ion mobility separator 46 essentially corresponds to the trapped ion mobility separator 10 from FIG. 1 in terms of its structure and its (first) mode of operation. Identical elements are provided with the same reference signs. In this respect, reference is also made to the preceding description.

The trapped ion mobility separator 46 differs from the trapped ion mobility separator 10 from FIG. 1 in that it comprises a plurality of ion guides 12. In the embodiment example the trapped ion mobility separator 46 comprises five ion guides 12a-12e, each having the same structure and being operated in the same mode (for example, as described with reference to FIG. 1). The ion guides 12a-12e are arranged sequentially. Further, an ion channel 48 of the trapped ion mobility separator 46 differs from the ion channel 42 of the trapped ion mobility separator 10 in its elongated structure, linking the individual ion guides 12a-12e of the trapped ion mobility separator 46. Thus, the ion channel 48 is set up to direct the ions to be injected into one of the ion guides 12 along these sequentially arranged ion guides 12a-12e. The sequentially arranged ion guides 12a-12e each provide an ion entrance region for a certain period of time, while the respective others do not provide an ion entrance region during this time, so that ions can enter the respective predetermined ion guide 12 each over a defined period of time. Ions ejected from any of the ion guides 12a-12e are forwarded by the ion channel 48 for further analyses. As described with reference to FIG. 4, potentials to be applied to the pairs of central electrodes are provided by a plurality of generators, set up to generate time-dependent voltage each. In particular, in the embodiment example the ion guides 12a-12e are operated with a temporal offset to allow a synchronized ejection of an ion species from sequentially arranged ion guides 12a-12e such that an ion species ejected from the first ion guide 12 and last ion guide 12e reach the end of the ion channel at the same (synchronized) time.

It is also conceivable that multiple electric field barriers, as described with reference to FIG. 5, are formed within each of the plurality of ion guides 12a-12e.

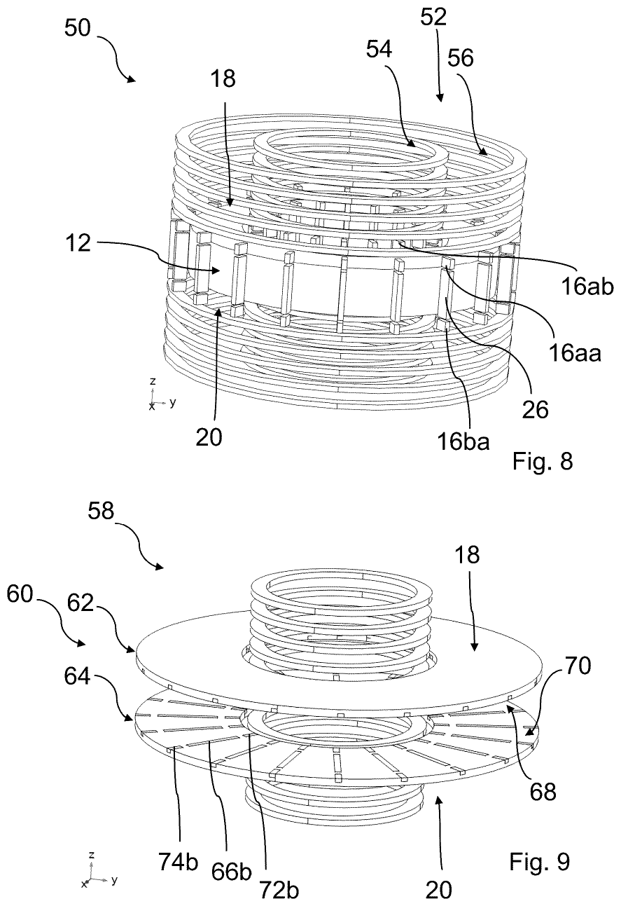

FIG. 8 shows a schematic perspective view of a third embodiment of a trapped ion mobility separator 50 according to the invention. Thus, the trapped ion mobility separator 50 is a moving barrier trapped ion mobility separator (mbTIMS). The trapped ion mobility separator 50 essentially corresponds to the trapped ion mobility separator 10 from FIG. 1 in terms of its structure and its (first) mode of operation. Identical elements are provided with the same reference signs. In this respect, reference is also made to the preceding description.

The trapped ion mobility separator 50 differs from the trapped ion mobility separator 10 from FIG. 1 in a structure of the ion channel 52. The ion channel 52 comprises an inner boundary, representing an inner radius 54. Further, the ion channel 52 comprises an outer boundary, representing an outer radius 56. Between the outer radius and the inner radius, a gap is provided. The gap represents an annulus, i.e., the difference between the outer radius and the inner radius, through which the ions pass.

Further, caused by the structure of the ion channel 52, the trapped ion mobility separator 50 differs from the trapped ion mobility separator 10 from FIG. 1 in that the ions are injected into the ion guide 12 in an axial direction, through the bottom-side 20 of the ion guide 12, and ejected from the ion guide 12 in an axial direction, through the top-side 18 of the ion guide 12.

Further, caused by the structure of the ion channel 52, the trapped ion mobility separator 50 differs from the trapped ion mobility separator 10 from FIG. 1 in that the central electrodes are realized differently in arrangement and design. Instead of arranging the pairs of central electrodes with a first central electrode arranged on the top-side 18 of the ion guide 12 and a second central electrode arranged on a bottom-side 20 of the ion guide 12, for every pair of central electrodes the first and second central electrode are segmented into two segments each. In the embodiment example, a first segment 16aa of the first central electrode is arranged above the outer side electrode 26 and a second segment 16ab of the first central electrode is arranged above the inner side electrode (not shown in the figure). A comparable arrangement is realized for a first and second segment of the second central electrode. A first segment 16ba of the second central electrode is arranged below the outer side electrode 26 and a second segment (not shown in the figure) of the second central electrode is arranged below the inner side electrode (not shown in the figure).

FIG. 9 shows a schematic perspective view of a fourth embodiment of a trapped ion mobility separator 58 according to the invention. Thus, the trapped ion mobility separator 58 is a moving barrier trapped ion mobility separator (mbTIMS). The trapped ion mobility separator 58 essentially corresponds to the trapped ion mobility separator 10 from FIG. 1 in terms of its structure and its (first) mode of operation. Identical elements are provided with the same reference signs. In this respect, reference is also made to the preceding description.

The trapped ion mobility separator 58 differs from the trapped ion mobility separator 10 from FIG. 1 in a structure of the ion guide 60, arising from the fact that the electrodes are realized differently. Instead of comprising electrodes composed of electrode units which are formed as separate discrete electrode sheets each (as described with reference to FIG. 1), the ion guide 60 comprises a first and a second printed circuit board (PCB) 62, 64, arranged oppositely to each other for forming the closed loop ion guide 12 in-between, wherein the first printed circuit board 62 is arranged on the top-side 18 of the ion guide 60 and the second printed circuit board 64 is arranged on the bottom-side 20 of the ion guide 60. The first printed circuit board 62 comprises a plurality of central electrodes (not shown in the figure), embedded in evenly spaced intervals into a surface 68 of the first PCB 62 which faces a surface 70 of the second PCB 64. A plurality of inner electrodes and outer electrodes (not shown in the figure), a number each corresponding to the number of central electrodes, is also embedded in the surface of the first PCB 62, wherein the inner electrodes each are arranged on one side of the central electrodes facing the first (inner) side 24 of the ion guide 60, and the outer electrodes each are arranged on another side of the central electrodes facing the second (outer) side 28 of the ion guide 60. Correspondingly, the second printed circuit board 64 comprises a plurality of central electrodes 66b, embedded in evenly spaced intervals into the surface 70 of the second PCB 64 which faces the surface 68 of the first PCB 62; as well as a plurality of inner electrodes 72b and outer electrodes 74b, a number each corresponding to the number of central electrodes 66b, wherein the inner electrodes 72b are arranged on one side of the central electrodes 66b facing the first (inner) side 24 of the ion guide 60, and the outer electrodes 74b are arranged on another side of the central electrodes 66b facing the second (outer) side 28 of the ion guide 60.

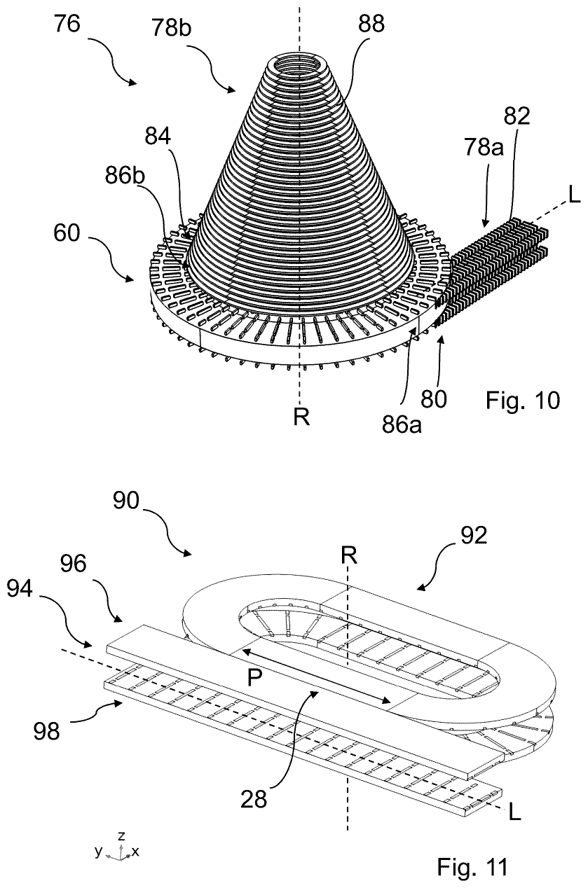

FIG. 10 shows a schematic perspective view of a fifth embodiment of a trapped ion mobility separator 76 according to the invention. Thus, the trapped ion mobility separator 76 is a moving barrier trapped ion mobility separator (mbTIMS). The trapped ion mobility separator 76 essentially corresponds to the trapped ion mobility separator 58 from FIG. 9 in terms of its structure and mode of operation. Identical elements are provided with the same reference signs. In this respect, reference is also made to the preceding description. For a better overview, solely the electrodes of the PCB structure are shown in the figure, but not the printed circuit board themselves. It is conceivable to use discrete electrodes instead of electrodes embedded in PCBs.

The trapped ion mobility separator 76 differs from the trapped ion mobility separator 58 from FIG. 9 in that a radius of the ion guide 60 is significantly larger than a radius of the ion guide of FIG. 9. In doing so, a high storage volume can be achieved. Further, the trapped ion mobility separator 76 differs from the trapped ion mobility separator 58 from FIG. 9 in its ion channel. The trapped ion mobility separator 76 has a first ion channel 78a to direct the ions to be injected into the ion guide towards the ion guide 60, and a second ion channel 78b to forward ions that are ejected from the ion guide 60.

The first ion channel 78a is arranged such that a longitudinal axis (L; shown as a dotted drawn line) of the ion channel 78a is essentially perpendicular to, and spatially offset from a rotation axis (R; shown as a dotted drawn line) of the ion guide 60. A first end 80 of the ion channel 78a is coupled to a portion of an outer edge 86a of the ion guide 60. The ion channel 78a comprises an array of electrodes, composed of segmented electrodes 82, shaped and arranged such, that ion channel 78a has a substantially rectangular cross section. For a better overview just one of the segmented electrodes 82 is provided with a reference sign.

The second ion channel 78b is arranged such that a rotation axis of the ion channel 78b is coaxial to the rotation axis of the ion guide 60. A first end 84 of the ion channel 78b is coupled to an inner edge 86b of the ion guide 60. The ion channel 78b comprises an array of electrodes, composed of stacked ring electrodes 88 being arranged evenly spaced from each other, wherein the electrodes 88 have a decreasing diameter along a direction of extension of the ion guide 78b. Thus, the ion guide 78b is shaped as an ion funnel. For a better overview just one of the ring electrodes 88 is provided with a reference sign.

FIG. 11 shows a schematic perspective view of a sixth embodiment of a trapped ion mobility separator 90 according to the invention. Thus, the trapped ion mobility separator 90 is a moving barrier trapped ion mobility separator (mbTIMS). The trapped ion mobility separator 90 essentially corresponds to the trapped ion mobility separator 58 from FIG. 9 in terms of its structure and mode of operation. Identical elements are provided with the same reference signs. In this respect, reference is also made to the preceding description.

The trapped ion mobility separator 90 differs from the trapped ion mobility separator 58 from FIG. 9 in a shape of its ion guide 92. The electrodes, embedded in the surface of PCBs, as described with reference to FIG. 9, are arranged such that the ion guide 92 has a substantially elliptical shape, in particular the ion guide 92 is stadium shaped.

Further, the trapped ion mobility separator 90 differs from the trapped ion mobility separator 58 from FIG. 9 in its mode of ejecting ions from the ion guide 92. As described with reference to FIG. 6, the ion exit region 32 is provided at fixed specific electrodes in one portion P (marked with a double-headed arrow) of the ion guide 92 such that the ions are ejected periodically at these specific electrodes. In particular, in the embodiment example, in the ion exit region 32 provided in the portion P of the ion guide 92, the PCBs comprise eight pairs of central electrodes and a number of related inner electrodes and outer electrodes.

Further, the trapped ion mobility separator 90 differs from the trapped ion mobility separator 58 from FIG. 9 in its ion channel 94. The ion channel 94 is arranged such that a longitudinal axis (L; shown as a dotted drawn line) of the ion channel 94 is essentially perpendicular to, and spatially offset from a rotation axis (R; shown as a dotted drawn line) of the ion guide 92. In particular, the ion channel 94 is arranged parallel to the portion P of the substantially elliptical shaped ion guide 92. Accordingly, in the embodiment example, the ions are injected into, and ejected from the ion guide 92 in a radial direction through the second side 28 of the ion guide 92. The ion channel 94 comprises an array of electrodes, composed of segmented electrodes, embedded in the surface of PCBs 96, 98 (comparable to the arrangement of electrodes within the PCBs creating the ion guide 92), shaped and arranged such that the ion channel 94 has a substantially rectangular cross section. For a better overview the segmented electrodes in the PCBs are not provided with a reference signs.

FIG. 12 shows a schematic diagram of a mass spectrometric system 100 according to the invention. The mass spectrometric system 100 is used for analyzing ions. The mass spectrometric system 100 comprises a plurality of analysis devices, which are described in the following.

The mass spectrometric system 100 comprises a separation device (not shown in the figure) for the separation of a mixture of substances. In the embodiment example, the separation device is a liquid chromatography device. Other separation devices (not shown in the figure), such as an electrophoretic device, may be provided and can be coupled to the mass spectrometric system 100.

Further, the mass spectrometric system 100 comprises an ion generator 110. The ion generator 110 comprises an ion source 112. In the embodiment example, the ion source 112 is an electrospray ion source (ESI). The ion source 112 operates at atmospheric pressure. Other ion source types which may be used include, for example, thermal spray, desorption ionization (e.g., matrix-assisted laser/desorption ionization (MALDI) or secondary ionization), chemical ionization (CI), photoionization (PI), electron impact ionization (EI), and gas-discharge ionization. Further, the ion generator 110 comprises an ion source chamber 114. The ion source chamber 114 is held at atmospheric pressure. In particular, the ion source chamber 114 incorporates the ion source 112. The ion generator 110 is located downstream of the liquid chromatography device. Further, a transfer capillary 116 is provided. The transfer capillary 116 has a first end 118. The first end 118 of the transfer capillary 116 is connected with the ion source chamber 114. Further, the transfer capillary 116 has a second end 120. The second end 120 of the transfer capillary 116 is connected with a vacuum chamber 124 of a trapped ion mobility separator 122. In particular, the transfer capillary 116 is set up to introduce ions generated by the (ESI) ion source 112 into the vacuum chamber 124. In the embodiment example, the transfer capillary 116 is a short wide bore capillary with an inner diameter of 1 mm or more and a length of 180 mm or less. Optionally, a single capillary with different length and diameter, multiple capillaries or single/multiple orifice inlets can be used to transfer the ions from the ion source chamber 114 to the vacuum chamber 124.

Further, the mass spectrometric system 100 comprises the trapped ion mobility separator 122. In the embodiment example, the trapped ion mobility separator is a moving barrier trapped ion mobility separator (mbTIMS) 122 according to the invention. In particular, in the embodiment example, the first trapped ion mobility separator 122 corresponds to the trapped ion mobility separator 10 from FIG. 1. In this respect, reference is also made to the preceding description. The trapped ion mobility separator 122 is located downstream of the ion generator 110. The trapped ion mobility separator 122 comprises the vacuum chamber 124. In the embodiment example, the vacuum chamber 124 is held at an elevated pressure between 300 Pa and 3000 Pa. It is conceivable, that, in another preferred embodiment, the vacuum chamber comprises an additional sub-ambient ESI ion source. Further, the trapped ion mobility separator 122 comprises a deflector electrode 126. It is conceivable, that, in another preferred embodiment, an additional MALDI source (not shown in the figure) can be located at the position of the deflector electrode. Further, the trapped ion mobility separator 122 comprises an entrance funnel 128, guiding the ions to the ion channel 130. In particular, the entrance funnel 128 is a RF-entrance funnel. Further, the trapped ion mobility separator 122 comprises the ion channel 130. The ion channel 130 is set up to direct ions to be injected into the ion guide 132 or to forward ions that are ejected from the ion guide 132. It is conceivable, that, in another preferred embodiment, the trapped ion mobility separator 122 comprises an ion trap, which is located within the ion channel 130 of the trapped ion mobility separator. Further, the trapped ion mobility separator 122 comprises the ion guide 132. The ion guide 132 is set up for trapping and separating ions. In the embodiment example, the trapped ion mobility separator 122 operates at a pressure of 5 mbar.

Further, the mass spectrometric system 100 comprises an ion guide apparatus 134. The ion guide apparatus 134 is set up for guiding ions. The ion guide apparatus 134 is located downstream of the mbTIMS 122. The ion guide apparatus 134 comprises an RF-ion guide 136. Further, the ion guide apparatus 134 comprises an ion guide chamber 138. The ion guide chamber 138 incorporates the RF-ion guide 136.

Further, the mass spectrometric system 100 comprises the mass filter apparatus 140. The mass filter apparatus 140 is set up to guide or select ions according to mass. The mass filter apparatus 140 is located downstream of the ion guide apparatus 134. The mass filter apparatus 140 comprises a mass filter 142. In the embodiment example, the mass filter 142 is a quadrupole mass filter. Further, the mass filter apparatus 140 comprises a mass filter chamber 144. The mass filter chamber 144 contains the quadrupole mass filter 142.

Further, the mass spectrometric system 100 comprises a fragmentation cell 146. The fragmentation cell 146 is set up to fragment larger ions to allow mass spectrometric measurement of the ion fragments. The fragmentation cell 146 is located downstream of the mass filter apparatus 140. In the embodiment example, fragmentation is done using collision induced dissociation (CID). However, any other known type of fragmentation may also be used including, but not limited to, infrared multiple photon-dissociation (IRMPD) or ultraviolet photo-dissociation (UVPD), surface induced dissociation (SID), photo-dissociation (PD), electron capture dissociation (ECD), electron transfer dissociation (ETD), collisional activation after electron transfer dissociation (ETcD), activation concurrent with electron transfer dissociation (AI-ETD) and fragmentation by reactions with highly excited or radical neutral particles. The fragmentation cell 146 comprises electrodes 148. Further, the fragmentation cell 146 comprises a fragmentation cell chamber 150. The fragmentation cell chamber 150 contains the electrodes 148. The fragmentation by CID can be switched on and off, controlled by instrumental parameters, e.g., an axial acceleration voltage. Precursor ions can be trapped in the fragmentation cell 146 without being fragmented, as well as fragment ions when fragmentation is enabled.

Further, the mass spectrometric system 100 comprises a mass analyzer 152. In the embodiment example, the mass analyzer 152 is a time-of-flight analyzer with orthogonal ion injection (OTOF-MS). Other possible mass analyzers include an electrostatic ion trap, an RF ion trap, an ion cyclotron frequency ion trap and a quadrupole mass filter. The mass analyzer 152 is set up to analyze ions according to mass. The mass analyzer 152 is located downstream of the fragmentation cell 146. The mass analyzer 152 comprises an accelerator 154 (or pulser). Further, the mass analyzer 152 comprises a flight tube 156. In the embodiment example, the flight tube 156 is field free. Further, the mass analyzer 152 comprises a reflector 158. Further, the mass analyzer 152 comprises an ion detector 160. An additional reflector can be located between the accelerator 154 and the ion detector 160 such that the ions are reflected twice in the reflector 158 and move on w-shaped trajectories instead of V-shaped trajectories.

In the following, the basic mode of operation of the mass spectrometric system 100 according to the invention is described:

Sample material is eluted from the liquid chromatography device (not shown in the figure). Ions are generated by the (ESI) ion source 112 using the sample material eluted from the liquid chromatography device. Via the transfer capillary 116, the generated ions are introduced into the first vacuum chamber 124 of the first trapped ion mobility separator, the mbTIMS 122. Subsequently, the ions are deflected into the RF-entrance funnel 128 of the mbTIMS 122 by a repelling electric DC-potential applied to the deflector electrode 126 of the mbTIMS 122. The RF-entrance funnel 128 collects the ions and guides them to the ion channel 130 of the mbTIMS 122. The ions are directed towards the ion guide 132 by the ion channel 130 to be injected into the ion guide 132 at an ion entrance region. In the ion guide 132 an electric field barrier is generated. By moving the electric field barrier, ions with different ion mobilities are accumulated at individual balanced positions (equilibrium points) along the electric field barrier, thus being separated according to their ion mobility. At the same time, the ions are urged by the moving electric field barrier to move along the drift length of the ion guide 12, whereby the ions are trapped at these individual positions as long as a moving speed or an electric field strength of the moving electric field barrier remains constant. By continuously increasing a moving speed of the electric field barrier and decreasing the electric field strength of the moving electric field barrier as a function of time while moving the electric field barrier around the closed loop ion guide, fractions of trapped ions are driven progressively to the high electric field end of the electric field barrier as a function of their ion mobility, being ejected continuously in time, when reaching the high electric field end of the moving electric field barrier, where an ion exit region is provided.

Subsequently, the ions released from the mbTIMS 122 enter the downstream located ion guide chamber 134 of the ion guide apparatus 136. The RF-ion guide 136 guides the ions into the further downstream located mass filter chamber 144 of the mass filter apparatus 140, in which the mass filter 142 is located. In the mass filter 142, ions are guided or selected according to mass. Subsequently, the ions that pass through the mass filter 140 are directed to the fragmentation cell 146, located downstream of the mass filter apparatus 140 in the fragmentation cell chamber 150. In the fragmentation cell 146, larger ions are dissociated into fragment ions to allow mass spectrometric measurement of the ion fragments. DC-voltages are applied to the electrodes 148 of the fragmentation cell 146 to generate an axial DC-field for ejecting the ion fragments into the downstream located mass analyzer 152, where they are analyzed according to their mass.

The invention has been shown and described above with reference to a number of different embodiments thereof. It will be understood, however, by a person skilled in the art that various aspects or details of the invention may be changed, or various aspects or details of different embodiments may be arbitrarily combined, if practicable, without departing from the scope of the invention. Generally, the foregoing description is for the purpose of illustration only, and not for the purpose of limiting the invention, which is defined solely by the appended claims, including any equivalent implementations, as the case may be.

### REFERENCE SIGNS

10 trapped ion mobility separator
12 ion guide
14 drift length
16a first central electrode
16aa first segment of the first central electrode
16ab second segment of the first central electrode
16b second central electrode
16ba first segment of the second central electrode
18 top-side of the ion guide
20 bottom-side of the ion guide
22a inner electrode
24 first side of the ion guide
26 outer electrode
28 second side of the ion guide
32 ion exit region
34 electrical component
36 DC voltage generator
40 electrical controller
42 ion channel
44 ring electrodes
46 trapped ion mobility separator
48 ion channel
50 trapped ion mobility separator
52 ion channel
54 inner radius of the ion channel
56 outer radius of the ion channel
58 trapped ion mobility separator
60 ion guide
62 first printed circuit board (PCB)
64 second printed circuit board (PCB)
66b second central electrode
68 surface of the first PCB
70 surface of the second PCB
72b inner electrode
74b outer electrode
76 trapped ion mobility separator
78a first ion channel
78b second ion channel
80 first end of the ion channel 78a
82 segmented electrode
84 first end of the ion channel 78b
86a outer edge
86b inner edge
88 ring electrode
90 trapped ion mobility separator
92 ion guide
94 ion channel
96 printed circuit board
98 printed circuit board
100 mass spectroscopic system
110 ion generator
112 ion source
114 ion source chamber
116 transfer capillary
118 first end of the transfer capillary
120 second end of the transfer capillary
122 trapped ion mobility separator
124 vacuum chamber
126 deflector electrode
128 entrance funnel
130 ion channel
132 ion guide
134 ion guide apparatus
136 RF-ion guide
138 ion guide chamber
140 mass filter apparatus
142 mass filter
144 mass filter chamber
146 fragmentation cell
148 electrodes
150 fragmentation cell chamber
152 mass analyzer
154 accelerator
156 flight tube
158 reflector
160 ion detector
A first section of the electric field barrier
B second first section of the electric field barrier
C third section
L longitudinal axis
R rotation axis
P portion of the ion guide
φ circular angle

1. A method of separating ions according to their ion mobility comprising the steps of:
providing an ion guide extending in a closed loop, with at least one ion entrance region at which ions are injected into said ion guide, said ion guide containing a gas which is substantially at rest and through which the ions pass along a drift length of said ion guide, and said ion guide comprising a plurality of electrodes shaped and arranged to guide the ions along said drift length of said ion guide, wherein at least some of the electrodes are supplied at least temporally with confining potentials for preventing the ions from escaping said ion guide laterally,
generating an axial force that is imparted to the ions along said drift length of said ion guide by applying potentials to the electrodes for forming at least one electric field barrier within said ion guide that has a low electric field end and a high electric field end and that moves around said closed loop ion guide, wherein the moving electric field barrier comprises at least a first section represented by an electric field gradient, and wherein the moving electric field barrier urges the ions to move along said drift length of said ion guide whereby the ions are separated according to their ion mobility along said electric field barrier,
varying at least one operating parameter, which has an impact on the mobility separation, as a function of time while moving said electric field barrier around said closed loop ion guide, for pushing at least one ion species controlled along said first section of the moving electric field barrier towards said high electric field end of said electric field barrier; and
providing at least one ion exit region in said ion guide and ejecting the at least one ion species laterally from said ion guide in said at least one ion exit region before slipping over said moving electric field barrier.

2. The method according to claim 1, wherein varying at least one operating parameter comprises at least one of (i) increasing a movement speed of said electric field barrier, (ii) decreasing the electric field strength of said moving electric field barrier, (iii) increasing a pressure of said gas through which the ions pass, and (iv) decreasing a temperature of said gas through which the ions pass.

3. The method according to claim 1, wherein said moving electric field barrier comprises a second section represented by a plateau with a substantially constant electric field, where said second section is spatially adjacent to said high electric field end of said electric field gradient.

4. The method according to claim 1, wherein said moving electric field barrier is formed along substantially the entire drift length of said ion guide.

5. The method according to claim 1, wherein said moving electric field barrier is formed within one portion of the drift length of said ion guide.

6. The method according to claim 5, wherein one or more additional moving electric field barriers are formed within said ion guide, said moving electric field barriers being formed in sequence along said drift length of said ion guide, preferably each of said additional moving electric field barriers comprise a first section represented by an electric field gradient, and a second section represented by a plateau with a substantially constant electric field, said second section being spatially adjacent to a high electric field end of the electric field gradient each.

7. The method according to claim 6, comprising providing one or more additional ion exit regions at least temporally in said ion guide, where preferably the number of ion exit regions is corresponding to the number of said moving electric field barriers and each of said moving electric field barriers is assigned with one of said ion exit regions.

8. The method according to claim 1, wherein to cause said axial force transient electric direct current (DC) potentials are applied to said electrodes to generate a transient axial direct current field (DC field).

9. The method according to claim 8, wherein said transient electric direct current (DC) potentials applied to said electrodes are provided by a plurality of DC voltage generators which generate time-dependent voltages each, wherein each of said electrodes is connected to a separate one of said DC voltage generators.

10. The method according to claim 1, wherein the ions are injected into said ion guide at an ion entrance region extending over the electrodes along substantially the entire length of said ion guide, or at an ion entrance region being provided at fixed specific electrodes in one or more portions of said ion guide.

11. The method according to claim 1, wherein the ions are ejected from said ion guide at an ion exit region that is provided adjacent to said high electric field end of said moving electric field barrier and moved with said moving electric field barrier such that the ions are ejected continuously in time when reaching said high electric field end of said moving electric field barrier, or at an ion exit region that is provided at least temporally at fixed specific electrodes in one or more portions of said ion guide such that the ions are ejected at said specific electrodes.

12. The method according to claim 1, comprising providing a potential barrier adjacent to said high electric field end of said moving electric field barrier for preventing ions from slipping over said moving electric field barrier before ejecting.

13. The method according to claim 1, wherein the ions are injected into said ion guide or ejected from said ion guide in a radial direction through a side of said ion guide.

14. The method according to claim 1, wherein the ions are injected into said ion guide or ejected from said ion guide in an axial direction, through a top or a bottom of said ion guide.

15. The method according to claim 1, comprising providing an ion channel which directs ions to be injected into said ion guide towards said ion guide and/or forwards ions that are ejected from said ion guide.

16. The method according to claim 1, wherein prior to ejection, direct current (DC) potentials are applied to said electrodes of said ion guide such that a lateral electric field is generated which keeps the ions inside of said ion guide, and/or during ejection, direct current (DC) potentials applied to the electrodes are adjusted in said section of said ion guide providing said ion exit region to eject the ions laterally.

17. The method according to claim 1, wherein said electric field barrier is moved with a velocity of less than 1000 m/s, preferably less than 750 m/s, most preferably less than 500 m/s.

18. The method according to claim 1, wherein said gas through which the ions pass is one of nitrogen (N), helium (He), neon (Ne), argon (Ar), sulfur hexafluoride (SF₆), hydrogen (H), air, or a mixture of any combination of the aforementioned.

19. A trapped ion mobility separator comprising:
an ion guide extending in a closed loop, comprising at least one ion entrance region at which ions are injected into said ion guide, and comprising at least one ion exit region at which ions are ejected from said ion guide, said ion guide containing a gas which is substantially at rest and through which the ions pass along a drift length of said ion guide, and said ion guide comprising a plurality of electrodes shaped and arranged to guide the ions along said drift length of said ion guide, wherein at least some of the electrodes are supplied at least temporally with confining potentials for preventing the ions from escaping said ion guide laterally,
at least one generator that causes an axial force to be exerted on the ions along said drift length of said ion guide by applying potentials to the electrodes for forming at least one electric field barrier within said ion guide that has a low electric field end and a high electric field end and that moves around said closed loop ion guide, wherein the moving electric field barrier comprises at least a first section represented by an electric field gradient, and wherein the moving electric field barrier urges the ions to move along said drift length of said ion guide whereby the ions are separated according to their ion mobility along said electric field barrier,
an electrical controller which communicates with said generator to vary at least one operating parameter of the trapped ion mobility separator, which has an impact on the mobility separation, as a function of time while moving said electric field barrier around said closed loop ion guide for pushing at least one ion species controlled along said first section of the moving electric field barrier towards said high potential end, wherein the at least one ion species is ejected laterally from said ion guide in said ion exit region before slipping over said electric field barrier.

20. The trapped ion mobility separator according to claim 19, wherein to vary at least one operating parameter comprises at least one of (i) increasing a movement speed of said electric field barrier, (ii) decreasing the electric field strength of said moving electric field barrier, (iii) increasing a pressure of said gas through which the ions pass, and (iv) decreasing a temperature of said gas through which the ions pass.

21. The trapped ion mobility separator according to claim 19, wherein said generator is set up to apply potentials to said electrodes such that a plateau with a substantially constant electric field is formed adjacent to said high electric field end of said electric field gradient, representing a second section of said moving electric field barrier.

22. The trapped ion mobility separator according to claim 19, wherein said generator is set up to apply potentials to said electrodes such that one or more additional electric field barriers are formed within said ion guide, said additional electric field barriers preferably corresponding to the first electric field barrier in their structure and being arranged in sequence along said drift length of said ion guide.

23. The trapped ion mobility separator according to claim 19, comprising a plurality of DC voltage generators, where the number of DC voltage generators is corresponding to the number of said electrodes forming said closed loop ion guide, and wherein each of said electrodes is assigned with one of said DC voltage generators.

24. The trapped ion mobility separator according to claim 19, wherein said electrodes are arranged such, that said ion guide has a substantially circular or elliptical shape, or that said ion guide has a an “8”-like shape, where preferably in said ‘8’-like shape trajectories of the ions moving along said ion guide do not cross but extend at least partly in different planes.

25. The trapped ion mobility separator according to claim 19, wherein said plurality of electrodes comprises apertured electrodes and/or electrode modules composed of electrode units each, wherein said apertured electrodes and/or electrode units are shaped and/or arranged such that said ion guide has a substantially convex cross section.

26. The trapped ion mobility separator according to claim 19, further comprising an ion channel comprising an array of electrodes to direct ions to be injected into said ion guide towards said ion guide and/or to forward ions that are ejected from said ion guide.

27. The trapped ion mobility separator according to claim 26, wherein a rotation axis of said ion channel is substantially coaxial to a rotation axis of said ion guide.

28. The trapped ion mobility separator according to claim 26, wherein a longitudinal axis of said ion channel is substantially perpendicular to a rotation axis of said ion guide.

29. The trapped ion mobility separator according to claim 26, further comprising an ion trap for storing ions, located upstream of said ion guide within said ion channel.

30. The trapped ion mobility separator according to claim 26, further comprising at least a second ion guide, preferably having the same structure, and being operated in the same mode as said first ion guide, wherein said first ion guide and said second ion guide are linked with each other by said ion channel.

31. The trapped ion mobility separator according to claim 19, being coupled to a vacuum system that is designed and configured to operate the trapped ion mobility separator at a gas pressure in a range of 0.1 mbar to 20 mbar, preferably of 2 mbar to 10 mbar.

32. A mass spectrometric system comprising an ion source, a mass analyzer with an ion detector, and at least a first trapped ion mobility separator located downstream of said ion source and/or upstream of said mass analyzer, wherein said first trapped ion mobility separator comprises
an ion guide extending in a closed loop, comprising at least one ion entrance region at which ions are injected into said ion guide, and comprising at least one ion exit region at which ions are ejected from said ion guide, said ion guide containing a gas which is substantially at rest and through which the ions pass along a drift length of said ion guide, and said ion guide comprising a plurality of electrodes shaped and arranged to guide the ions along said drift length of said ion guide, wherein at least some of the electrodes are supplied at least temporally with confining potentials for preventing the ions from escaping said ion guide laterally,
at least one generator that causes an axial force to be exerted on the ions along said drift length of said ion guide by applying potentials to the electrodes for forming at least one electric field barrier within said ion guide that has a low electric field end and a high electric field end and that moves around said closed loop ion guide, wherein the moving electric field barrier comprises at least a first section represented by an electric field gradient, and wherein the moving electric field barrier urges the ions to move along said drift length of said ion guide whereby the ions are separated according to their ion mobility along said electric field barrier,
an electrical controller which communicates with said generator to vary at least one operating parameter of the trapped ion mobility separator, which has an impact on the mobility separation, as a function of time while moving said electric field barrier around said closed loop ion guide for pushing at least one ion species controlled along said first section of the moving electric field barrier towards said high potential end, wherein the at least one ion species is ejected laterally from said ion guide in said ion exit region before slipping over said electric field barrier.

33. The mass spectrometric system according to claim 32, wherein to vary at least one operating parameter comprises at least one of (i) increasing a movement speed of said electric field barrier, (ii) decreasing the electric field strength of said moving electric field barrier, (iii) increasing a pressure of said gas through which the ions pass, and (iv) decreasing a temperature of said gas through which the ions pass.
